(19) United States
(12) Patent Application Publication
(10) Pub. No.: US 2025/0013718 A1
(43) Pub. Date: Jan. 9, 2025

(54) ARITHMETIC AND COMMUNICATION MINIMIZING FAST MATRIX MULTIPLICATION

(71) Applicant: YISSUM RESEARCH DEVELOPMENT COMPANY OF THE HEBREW UNIVERSITY OF JERUSALEM LTD., Jerusalem (IL)

(72) Inventors: Oded SCHWARTZ, Kiryat Ono (IL); Yoav MORAN, Jerusalem (IL); Noa VAKNIN, Jerusalem (IL)

(21) Appl. No.: 18/815,452

(22) Filed: Aug. 26, 2024

Related U.S. Application Data
(63) Continuation-in-part of application No. 17/437,816, filed on Sep. 9, 2021.
(60) Provisional application No. 62/816,979, filed on Mar. 12, 2019.

(51) Int. Cl. G06F 17/16

(52) U.S. Cl. CPC G06F 17/16

(57) ABSTRACT

A computer-implemented method comprising: receiving two or more input matrices for a multiplication operation; determining, for each of the input matrices, a series of transformations, and applying the series of transformations respectively to the input matrices to obtain transformed the input matrices, wherein each of the series of transformations reduces a number of arithmetic operations required to perform the multiplication operation, given a desired value of communication costs required to perform the multiplication operation using the computer system, and wherein each of the series of transformations is performed over two or more recursions, wherein at least one of the recursions comprises at least two the transformations; applying a recursive bilinear computation to the transformed two or more input matrices, thereby producing a transformed multiplied matrix; and determining an output series of transformations which are applied to the transformed multiplied matrix, to obtain a product of the input matrices.

### CROSS-REFERENCE TO RELATED APPLICATIONS

This application is a continuation-in-part of U.S. patent application Ser. No. 17/437,816, filed Sep. 9, 2021, which is a National Phase of PCT Patent Application No. PCT/IL2020/050302 having an International filing date of Mar. 12, 2020, which claims the benefit of priority of U.S. Provisional Patent Application Ser. No. 62/816,979, filed Mar. 12, 2019, entitled “Faster Matrix Multiplication Via Sparse Decomposition,” the contents of all of which are incorporated herein by reference in their entirety.

### STATEMENT REGARDING SPONSORED RESEARCH OR DEVELOPMENT

The project leading to this application has received funding from the European Research Council (ERC) under the European Union's Horizon 2020 research and innovation programme (grant agreement No 101113120 and 818252).

### BACKGROUND

The invention relates to the field of computerized mathematical applications.

Matrix multiplication is used in a wide range of computerized applications, from image processing to genetic analysis. For example, matrix multiplication is used in cryptography, random numbers, error correcting codes, and image processing. One example is in cryptanalysis, where chained operations described as matrices must be multiplied together before being analyzed for flaws. Another example is in the design of random-number generators, where exponentiation (i.e. repeated multiplication) of dense matrices is used to determine the period and quality of random number generators. The results of matrix mathematics can be seen in every computer-generated image that has a reflection, or distortion effects such as light passing through rippling water. For example, graphics cards use matrix mathematics to account for reflection and for refraction.

As a result of its wide usage, matrix multiplication is an integral feature of computer microprocessors, such as CPUs (Central Processing Units), GPUs (Graphic Processing Units), embedded processors, FPGAs (Field-Programmable Gate Arrays), and the like. Matrix multiplication may be part of a system kernel, such as an operating system kernel, a math library kernel, a graphics processing kernel, and/or the like. The matrix multiplication may be performed by a combination of hardware and software components that are coordinated to produce the matrix results, such as in parallel processor operating system kernels that use multiple hardware processors to perform matrix multiplications.

Many techniques have been developed to improve the computational efficiency, speed, memory use, communications use, etc., of computerized matrix multiplication. For example, Strassen's well-known matrix multiplication algorithm is a sub-cubic matrix multiplication algorithm, with a complexity of O(n^{log}^{₂}⁷). See Volker Strassen, “Gaussian elimination is not optimal”, in Numerische mathematik 13, 4 (1969), 354-356. The leading coefficient of Strassen's algorithm's cost is 7, namely, the arithmetic cost is 7n^{log}^{₂}⁷−6n² (as opposed to 2, of the classical algorithm). Winograd's matrix multiplication algorithm may reduce the leading coefficient from 7 to 6 by decreasing the number of additions and subtractions from 18 to 15. See Shmuel Winograd, “On multiplication of 2×2 matrices”, in Linear algebra and its applications 4, 4 (1971), 381-388.

Fast matrix multiplication algorithms are of practical use only if the leading coefficient of their arithmetic complexity is sufficiently small. Many algorithms with low asymptotic cost have large leading coefficients and are thus impractical. Thus, in practice, Strassen-Winograd's algorithm for matrix multiplication may perform better than some asymptotically faster algorithms due to these smaller hidden constants. The leading coefficient of Strassen-Winograd's algorithm may be optimal, due to a lower bound on the number of additions for matrix multiplication algorithms with 2×2 base case, obtained by Robert L. Probert, “On the additive complexity of matrix multiplication”, in SIAM J. Comput. 5, 2 (1976), 187-203. As used herein, the term “additions” may be in some circumstances used interchangeably with the word “subtraction,” as appropriate within the context.

Strassen-like algorithms are a class of divide-and-conquer algorithms which may utilize a base [symbol] n₀, m₀, k₀; t [symbol] -algorithm: multiplying an n₀×m₀ matrix by an m₀×k₀ matrix using t scalar multiplications, where n₀, m₀, k₀ and t are positive integers. When multiplying an n×m matrix by an m×k matrix, an algorithm may split the matrices into blocks (such as each of size

$$\frac{n}{{n}_{0}} \times \frac{m}{{m}_{0}} and \frac{m}{{m}_{0}} \times \frac{k}{{k}_{0}} ,$$

respectively), and may proceed block-wise, according to the base algorithm. Additions and multiplication by a scalar in the base algorithm may be interpreted as block-wise additions. Multiplications in the base algorithm may be interpreted as block-wise multiplication via recursion. As used herein, a Strassen-like algorithm may be referred to by its base case. Hence, an (n, m, k; t)-algorithm may refer to either the algorithm's base case or the corresponding block recursive algorithm, as obvious from context.

Recursive fast matrix multiplication algorithms with reasonable base case size for both square and rectangular matrices have been developed. At least some may have manageable hidden constants, and some asymptotically faster than Strassen's algorithm (e.g., Kaporin's implementation of Laderman algorithm; see Igor Kaporin, “The aggregation and cancellation techniques as a practical tool for faster matrix multiplication” in Theoretical Computer Science 315, 2-3, 469-510).

Smirnov presented several fast matrix multiplication algorithms derived by computer aided optimization tools, including an [symbol] 6,3,3; 40 [symbol] -algorithm with asymptotic complexity of O(n^{log}^{₅₄}⁴⁰^{³}), i.e. faster than Strassen's algorithm. See AV Smirnov, “The bilinear complexity and practical algorithms for matrix multiplication”, in Computational Mathematics and Mathematical Physics 53, 12 (2013), 1781-1795. Ballard and Benson later presented several additional fast Strassen-like algorithms, found using computer aided optimization tools as well. They implemented several Strassen-like algorithms, including Smirnov's [symbol] 6,3,3; 40 [symbol] -algorithm, on shared-memory architecture in order to demonstrate that Strassen and Strassen-like algorithms can outperform classical matrix multiplication in practice (such as Intel's Math Kernel Library), on modestly sized problems (at least up to n=13000), in a shared-memory environment. Their experiments also showed Strassen's algorithm outperforming Smirnov's algorithm in some of the cases. See Austin R. Benson and Grey Ballard, “A framework for practical parallel fast matrix multiplication” in ACM SIGPLAN Notices 50, 8 (2015), 42-53.

Bodrato introduced the intermediate representation method, for repeated squaring and for chain matrix multiplication computations. See Marco Bodrato, “A Strassen-like matrix multiplication suited for squaring and higher power computation”, in Proceedings of the 2010 International Symposium on Symbolic and Algebraic Computation, ACM, 273-280. This enables decreasing the number of additions between consecutive multiplications. Thus, he obtained an algorithm with a 2×2 base case, which uses 7 multiplications, and has a leading coefficient of 5 for chain multiplication and for repeated squaring, for every multiplication outside the first one. Bodrato also presented an invertible linear function which recursively transforms a 2^{k}×2^{k} matrix to and from the intermediate transformation. While this is not the first time that linear transformations are applied to matrix multiplication, the main focus of previous research on the subject was on improving asymptotic performance rather than reducing the number of additions.

Karstadt and Schwartz demonstrated a technique that reduces the leading coefficient by introducing fast O(n² log n) basis transformations, applied to the input and output matrices. See Elaye Karstadt and Oded Schwartz. Matrix multiplication, a little faster. In Proceedings of the 29th ACM Symposium on Parallelism in Algorithms and Architectures, pages 101-110, 2017; Elaye Karstadt and Oded Schwartz. Matrix multiplication, a little faster. Journal of the ACM (JACM), 67 (1): 1-31, 2020.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment relates to a computer-implemented method comprising: receiving two or more input matrices for a multiplication operation to be performed using a computer system; determining, for each of the input matrices, a series of transformations, and applying the series of transformations respectively to the input matrices to obtain transformed the input matrices, wherein each of the series of transformations reduces a number of arithmetic operations required to perform the multiplication operation, given a desired value of communication costs required to perform the multiplication operation using the computer system, and wherein each of the series of transformations is performed over two or more recursions, wherein at least one of the recursions comprises at least two the transformations; applying a recursive bilinear computation to the transformed two or more input matrices, thereby producing a transformed multiplied matrix; and determining an output series of transformations which are applied to the transformed multiplied matrix, to obtain a product of the at least two input matrices, wherein the computer system comprises one or more processors and a communication network, wherein each of the processors is configured to perform matrix multiplication on blocks of size n, and wherein the computer system is configured to balance arithmetic and communication costs associated with performing the matrix multiplication, such that a time period required to transfer the blocks to a processor of the one or more processors via the communication network is approximately equal to a time period required to perform the matrix multiplication on the blocks by the processor.

Another embodiment relates to a system comprising at least one processor; and a non-transitory computer-readable storage medium having stored thereon program instructions, the program instructions executable by the at least one processor to: receive two or more input matrices for a multiplication operation, determine, for each of the input matrices, a series of transformations, and apply the series of transformations respectively to the input matrices to obtain transformed the input matrices, wherein each of the series of transformations reduces a number of arithmetic operations required to perform the multiplication operation, given a desired value of communication costs required to perform the multiplication operation using the system, and wherein each of the series of transformations is performed over two or more recursions, wherein at least one of the recursions comprises at least two the transformations, apply a recursive bilinear computation to the transformed two or more input matrices, thereby producing a transformed multiplied matrix, and determine an output series of transformations which are applied to the transformed multiplied matrix, to obtain a product of the at least two input matrices, wherein the system further comprises a communication network, wherein each of the at processors is configured to perform matrix multiplication on blocks of size n, and wherein the system is configured to balance arithmetic and communication costs associated with performing the matrix multiplication, such that a time period required to transfer the blocks to a processor of the one or more processors via the communication network is approximately equal to a time period required to perform the matrix multiplication on the blocks by the processor.

A further embodiment relates to a computer program product comprising a non-transitory computer-readable storage medium having program instructions embodied therewith, the program instructions executable by a computer system to: receive two or more input matrices for a multiplication operation, determine, for each of the input matrices, a series of transformations, and apply the series of transformations respectively to the input matrices to obtain transformed the input matrices, wherein each of the series of transformations reduces a number of arithmetic operations required to perform the multiplication operation, given a desired value of communication costs required to perform the multiplication operation using the computer system, and wherein each of the series of transformations is performed over two or more recursions, wherein at least one of the recursions comprises at least two the transformations, apply a recursive bilinear computation to the transformed two or more input matrices, thereby producing a transformed multiplied matrix, and determine an output series of transformations which are applied to the transformed multiplied matrix, to obtain a product of the at least two input matrices, wherein the computer system comprises one or more processors and a communication network, wherein each of the processors is configured to perform matrix multiplication on blocks of size n, and wherein the computer system is configured to balance arithmetic and communication costs associated with performing the matrix multiplication, such that a time period required to transfer the blocks to a processor of the one or more processors via the communication network is approximately equal to a time period required to perform the matrix multiplication on the blocks on the blocks by the processor.

A further embodiment relates to a computer system comprising one or more processors, each configured to perform matrix multiplication on blocks of size n; and a communication network, wherein the computer system is configured to balance arithmetic and communication costs associated with performing the matrix multiplication, such that a time period required to transfer the blocks to a processor of the one or more processors via the communication network is approximately equal to a time period required to perform the matrix multiplication on the blocks by the processor.

In some embodiments, the computer system is configured to perform a matrix multiplication operation with respect to two or more input matrices, the matrix multiplication operation comprising the following steps: receiving two or more input matrices for a multiplication operation to be performed using a computer system; determining, for each of the input matrices, a series of transformations, and applying the series of transformations respectively to the input matrices to obtain transformed the input matrices, wherein each of the series of transformations reduces a number of arithmetic operations required to perform the multiplication operation, given a desired value of communication costs required to perform the multiplication operation using the computer system, and wherein each of the series of transformations is performed over two or more recursions, wherein at least one of the recursions comprises at least two the transformations; applying a recursive bilinear computation to the transformed two or more input matrices, thereby producing a transformed multiplied matrix; and determining an output series of transformations which are applied to the transformed multiplied matrix, to obtain a product of the at least two input matrices.

In some embodiments, the balance is achieved by adjusting at least one of the following parameters: a silicone area of each of the processors, a processing speed of each of the processors, a size of a local memory associated with each of the processors, a size of a shared memory accessible to all of the processors, a bandwidth of the communication network, and/or a latency of the communication network.

In some embodiments, the adjusting is performed according to the equation

$$γ {M}^{\frac{{ω}_{0}}{2}} \approx c ( α + β M ) , n = Θ ( \sqrt{M} ) ,$$

where ω₀ denotes an exponent of the recursive bilinear computation, γ denotes the time required for a single arithmetic operation by a processor of the one or more processors, α denotes the latency, β denotes the bandwidth, M denotes a size of a local memory associated with each of the processors, n denotes a size of the blocks, and c is a constant determined by a number of read and write operations required for the matrix multiplication.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows schematically an exemplary computerized system for matrix multiplication using w into a linear space of any intermediate dimension, in accordance with an embodiment of the present invention;

FIG. 2 is a flowchart of a method for matrix multiplication using decompositions that are transformations which are not homomorphisms into a linear space of any intermediate dimension, in accordance with an embodiment of the present invention;

FIGS. 3A-3D show a comparison of the dimensions of encoding/decoding transformations of recursive-bilinear, alternative basis, decomposed, and fully decomposed algorithms, in accordance with an embodiment of the present invention;

FIG. 4 shows a full decomposition scheme, in accordance with an embodiment of the present invention;

FIG. 5 shows a graph comparing the arithmetic complexity of the classical algorithm, [symbol] 3,3,3; 23 [symbol] -algorithm, alternative basis [symbol] 3,3,3; 23 [symbol] -algorithm, decomposed [symbol] 3,3,3; 23 [symbol] -algorithm, and fully decomposed [symbol] 3,3,3; 23 [symbol] -algorithm, in accordance with an embodiment of the present invention;

FIG. 6 shows examples of decomposed algorithms, in accordance with an embodiment of the present invention; and

FIG. 7 shows an optimal decomposition of the [symbol] 3,3,3; 23 [symbol] -algorithm, in accordance with an embodiment of the present invention.

FIG. 8 shows a computation diagram of a sparse decomposition matrix multiplication.

FIG. 9 shows a computation diagram of a combined alternative basis matrix multiplication.

FIG. 10 shows a computation diagram of a fully decomposed sparse decomposition matrix multiplication.

FIG. 11 shows a computation diagram of a sparse decomposition method combined with the present technique of combined alternative basis.

### DETAILED DESCRIPTION

Disclosed herein is a computerized system, method, and computer program product for performing faster matrix multiplication via sparse decomposition. In some embodiments, the present disclosure provides for matrix multiplication using decompositions that are transformations which are not necessarily homomorphisms into a linear space of any intermediate dimension.

In some embodiments, a fast matrix multiplication algorithm of the present disclosure provides significantly improved leading coefficients, without a reduction in asymptotic complexity.

Many algorithms with low asymptotic cost have large leading coefficients, and are thus impractical. The Alternative Basis Method of Karstadt and Schwartz has demonstrated a technique that reduces the leading coefficient by introducing fast O(n² log n) basis transformations, applied to the input and output matrices.

Matrix Multiplication is a fundamental computation kernel, used in many parallel and sequential algorithms. Thus, improving matrix Multiplication performance has attracted the attention of many researchers. Strassen's algorithm was the first sub-cubic matrix multiplication algorithm. Since then, research regarding fast multiplication algorithms has bifurcated into two main streams.

The first focuses on deriving asymptotic improvements by reducing the exponent of the arithmetic complexity. Often, these improvements come at the cost of large “hidden constants,” rendering them impractical. Moreover, the aforementioned algorithms are typically only applicable to matrices of very large dimensions, further restricting their practicality.

The second line of research focuses on obtaining asymptotically fast algorithms while maintaining lower hidden costs; allowing multiplication of reasonably-sized matrices. These methods are thus more likely to have practical applications. Within this line of research, several algorithms have been discovered via computer-aided techniques.

Previously, the problem of matrix multiplication was reduced to the triple-product trace, allowing the derivation of several sub-cubic algorithms with relatively small base cases, such as [symbol] 70,70,70; 143640 [symbol] , [symbol] 40,40,40; 36133 [symbol] , and [symbol] 18,18,18; 3546 [symbol] , allowing multiplication in Θ(n^{ω}^{₀}), where ω₀=log₇₀143640≈2.79, ω₀=log₄₀36133≈2.84, and ω₀=log₁₈3546≈2.82, respectively. Notice that the notation [symbol] n, m, k; t [symbol] refers to an algorithm with a base case that multiplies matrices of dimension n×m, m×k using t scalar multiplications.

Later, a computer-aided search was used to find base cases. Notable among these algorithms are [symbol] 6,3,3; 40 [symbol] -algorithm, and [symbol] 4,3,3; 29 [symbol] -algorithm, allowing multiplication in Θ(n^{ω}^{₀}), where ω₀=log₅₄(40³)≈2.774 and ω₀=log₃₆(29³)≈2.818, respectively. Similarly, computer-aided techniques were further used to derive additional multiplication algorithms, such as [symbol] 5,2,2; 18 [symbol] and [symbol] 3,2,2; 11 [symbol] , allowing multiplication in Θ(n^{ω}^{₀}), where ω₀=log₂₀18³≈2.89 and ω₀=log₁₂113≈2.89, respectively.

In some embodiments, the present disclosure generalizes this technique, by allowing larger bases for the transformations while maintaining low overhead. Thus, in some embodiments, the present disclosure accelerates several known matrix multiplication algorithms, beyond what is known to be possible using previous techniques. Of particular interest are a few new sub-cubic algorithms with a leading coefficient 2, matching that of classical matrix multiplication. For example, an algorithm may be obtained with arithmetic complexity of 2n^{log}^{₃}²³+o(n^{log323}) compared to 2n³−n² of the classical algorithm. Such new algorithms can outperform previous ones (classical included) even on relatively small matrices. Thus, there are obtained lower bounds matching the coefficient of several algorithms, proving them to be optimal.

The hidden constants of the arithmetic complexity of recursive-bilinear algorithms, including matrix multiplication, is determined by the number of linear operations performed in the base case. Strassen's [symbol] 2,2,2; 7 [symbol] -algorithm has a base-case with 18 additions, resulting in a leading coefficient of 7. This was later reduced to 15 additions by Winograd, decreasing the leading coefficient from 7 to 6. Probert and Bshouty showed that 15 additions are necessary for any [symbol] 2,2,2; 7 [symbol] -algorithm, leading to the conclusion that the leading coefficient of Strassen-Winograd is optimal for the 2×2 base case.

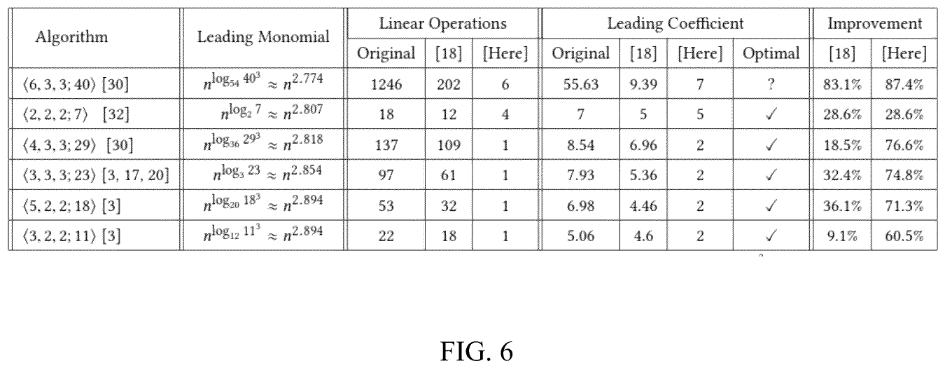

The Alternative Basis Method of Karstadt and Schwartz recently observed that these lower-bounds implicitly assume the input and output are given in the standard basis. Discarding this assumption allows further reduction in the number of arithmetic operations from 15 to 12, decreasing the leading coefficient to 5. The same approach, applied to other algorithms, resulted in a significant reduction of the corresponding leading coefficients (See FIG. 6). Moreover, the Alternative Basis Method extended the lower bounds due to Probert and Bshouty by allowing algorithms that include basis transformations, thus proving that their [symbol] 2,2,2; 7 [symbol] -algorithm obtains an optimal leading coefficient in the alternative basis regime.

Key to the approach of the Alternative Basis Method of are fast basis transformations, which can be computed in O(n² log n), asymptotically faster than the matrix multiplication itself. These transformations can be viewed as an extension of the “intermediate representation” approach, which previously appeared in Bodrato's method for matrix squaring.

Cenk and Hassan developed a technique for computing multiplication algorithms, such as Strassen's, which utilizes memorization, allowing a reduction of the leading coefficient. Their approach obtains a [symbol] 2,2,2; 7 [symbol] -algorithm with a leading coefficient of 5, as in the Alternative Basis Method of Karstadt and Schwartz, albeit with larger exponents in the low-order monomials.

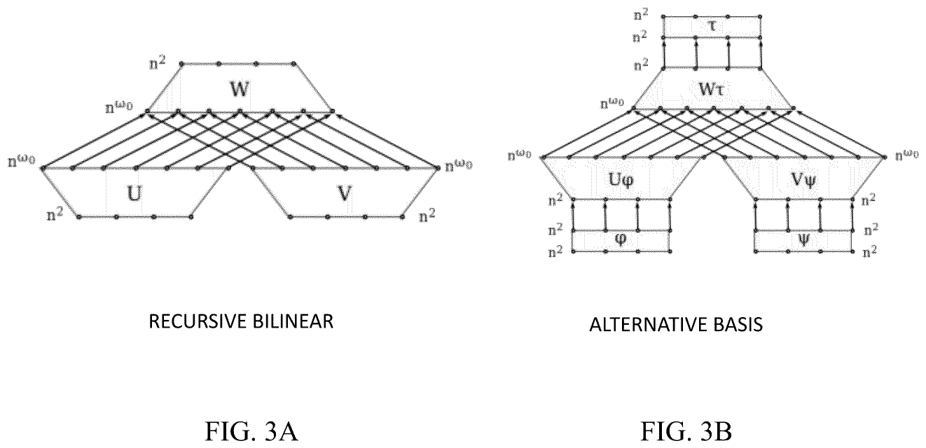

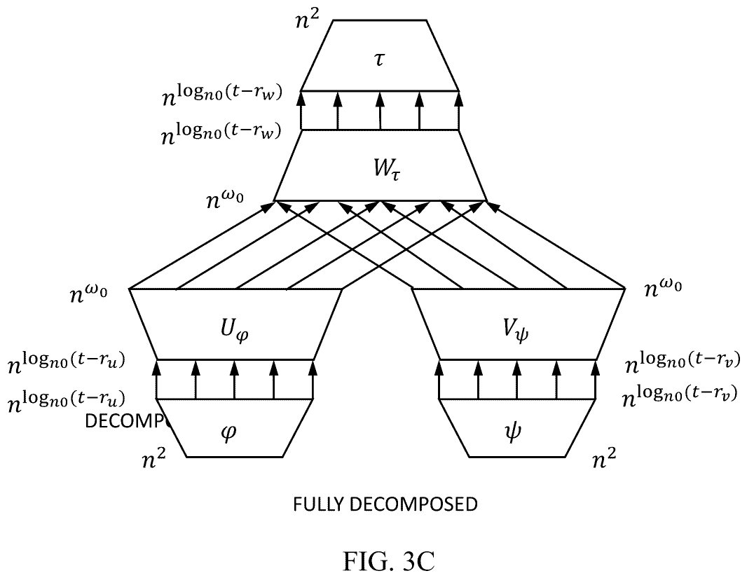

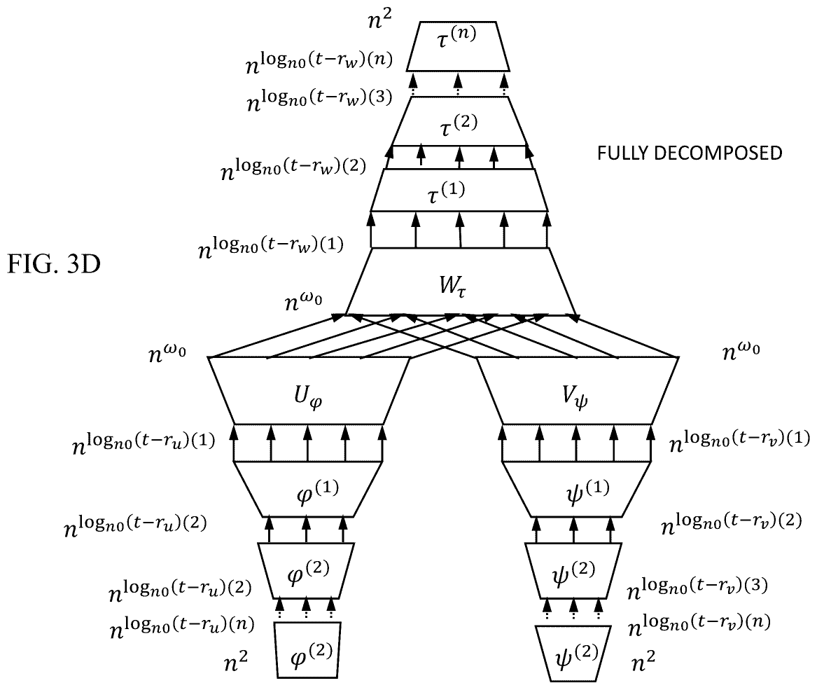

The present invention extends the Alternative Basis Method of Karstadt and Schwartz for Alternative Basis Multiplication. While their basis transformations are homomorphisms over the same linear space (i.e., changes of basis), the present invention considers non-homomorphic transformations into a linear space of any intermediate dimension (see FIGS. 3A-3D). Such transformations incur costs of low-order monomials, as opposed to the O(n² log n) cost of basis transformations, but allow further reduction of the leading (and other) coefficients.

The mixed-product property of the Kronecker Product was used to rearrange the computation graph, allowing aggregation of all the decompositions into a single stage of the algorithm. As the aforementioned transformations correspond to low-order monomials, part of the computation was intentionally “offloaded” onto them. To this end, decompositions in which the matrices of maps contributing to the leading monomial are sparse were used, whereas the matrices of transformations contributing to low-order monomials may be relatively dense.

The decomposition scheme was applied to several fast matrix multiplication algorithms, resulting in significant reduction of their arithmetic complexity compared to previous techniques. Several decomposed sub-cubic algorithms with leading coefficient 2, matching that of the classical multiplication algorithm, were found. Such algorithms outperform previous ones (classical included) even on small matrices. In particular, decompositions with said properties for [symbol] 4,3,3; 29 [symbol] -algorithm, [symbol] 3,3,3; 23 [symbol] -algorithm, [symbol] 5,2,2; 18 [symbol] -algorithm and [symbol] 3,2,2; 11 [symbol] -algorithm were obtained. Furthermore, optimally decomposed algorithms maintain the leading coefficient of 2 when converted into square [symbol] nmk, nmk, nmk; t³ [symbol] -algorithms (see FIG. 6).

Lastly, lower bounds for several of the leading coefficients were obtained. The lower bound for alternative basis [symbol] 2,2,2; 7 [symbol] -algorithms was extended, showing that even in the new framework, the leading coefficient of any [symbol] 2,2,2; 7 [symbol] -algorithm is at least 5, matching the best known coefficient. Furthermore, the leading coefficient of any [symbol] n, m, k; t [symbol] -algorithm in the new framework is at least 2, matching several of the obtained algorithms.

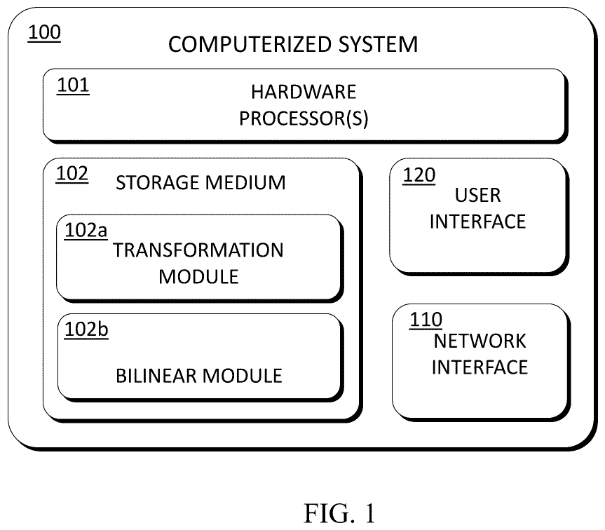

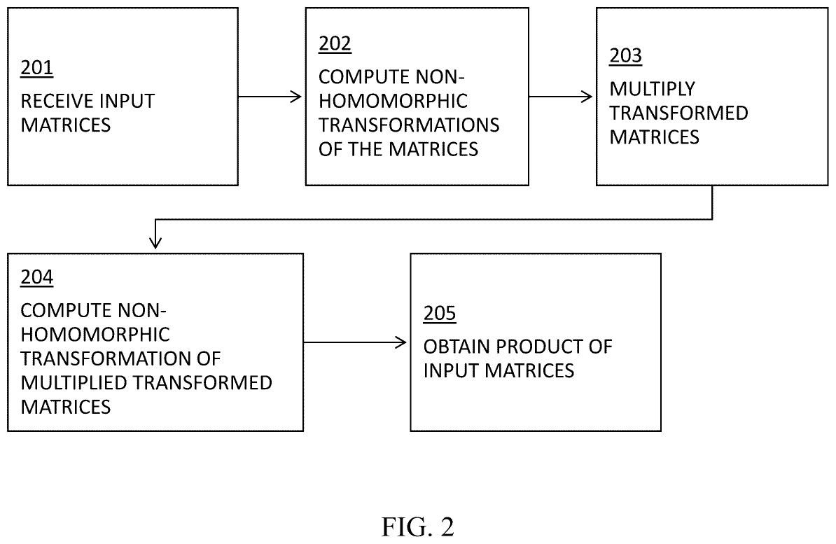

Reference is made to FIG. 1 which shows schematically an exemplary computerized system 100 for matrix multiplication using decompositions that are transformations which are not necessarily homomorphisms into a linear space of any intermediate dimension, in accordance with an embodiment of the present invention, and to FIG. 2, which shows a flowchart 200 of a method for matrix multiplication using decompositions that are transformations which are not homomorphisms into a linear space of any intermediate dimension, in accordance with an embodiment of the present invention. These embodiments are examples of possible embodiments that utilize the disclosed technique, and other embodiments may be envisions, such as field-programmable gate arrays embodiments, and/or the like. For example, the method may compute a basis transformation a priori, on the fly, retrieved from a repository, provided as a service, and/or the like.

Computerized system 100 comprises one or more hardware processors 101, a user interface 120, a network interface 110, and one or more computer-readable, non-transitory, storage mediums 102.

System 100 as described herein is only an exemplary embodiment of the present invention, and in practice may have more or fewer components than shown, may combine two or more of the components, or a may have a different configuration or arrangement of the components. The various components of system 100 may be implemented in hardware, software or a combination of both hardware and software. In various embodiments, system 100 may comprise a dedicated hardware device, or may form an addition to/or extension of an existing device. In some embodiments, system 100 may comprise numerous general purpose or special purpose computing system environments or configurations. Examples of computing systems, environments, and/or configurations that may be suitable for use with system 100 include, but are not limited to, personal computer systems, server computer systems, thin clients, thick clients, hand-held or laptop devices, multiprocessor systems, microprocessor-based systems, minicomputer systems, mainframe computer systems, distributed cloud computing environments that include any of the above systems or devices, and the like.

On non-transitory storage medium(s) 102 is stored program code, optionally organized in dedicated, specialized, non-standard software modules, that when executed on hardware processor(s) 101, cause hardware processor(s) 101 to perform non-standard actions resulting in matrix multiplication. The non-standard transformation module 102a optionally receives, at 201, input matrices, and based on the matrix multiplier technique, optionally determines, at 202, decompositions of the matrices that are transformations which are not homomorphisms into a linear space of any intermediate dimension. Transformation module 102a then applies the decompositions to transform, at 203, the input matrices. A bilinear module 102b multiplies, at 204, the transformed input matrices to produce a transformed results matrix, which is inverse transformed by transformation module 102a to produce, at 205, the resulting multiplied matrix.

### Notations

Let t∈ [symbol] . The notation [t] represents the set:

[t]=1,2, . . . , t.

Let R be a ring and let l, n, m∈ [symbol] . Denote N =n^{l}, M=m^{l}. Let A∈R^{N×M} be a matrix. Denote A_{i,j} the (i,j)-th block of size

$$\frac{N}{n} \times \frac{M}{m} .$$

The block-row order vectorization of A corresponding to blocks of size

$$\frac{N}{n} \times \frac{M}{m} ,$$

is recursively defined as follows:

\vec{A}=(\vec{A}_{1,1} . . . \vec{A}_{1,m} . . . \vec{A}_{n,1} . . . \vec{A}_{n,m})^{T}.

Denote the number of non-zero entries in a matrix by (A)=|x∈A:x≠0|

Denote the number of non-singleton entries in a matrix by (A)=|x∈A:x∈0, +1, −1|.

Let R be a ring and let l, n, m∈ [symbol] . Denote N=n^{l}, M=m^{l}. Let a∈R^{NM} be a vector, and let:

$$∀ i ∈ [ nm ] : {a}^{( i )} = ( {a}_{\frac{N M}{n m} \cdot ( i - 1 ) + 1} , … , {a}_{\frac{N M}{n m} \cdot i} )$$

The block segmentation of α is denoted:

$$\hat{a} = {( {a}^{( 1 )} , … , {a}^{( n m )} )}^{T} ∈ {( {R}^{\frac{N M}{n m}} )}^{n m}$$

### Recursive Bilinear Algorithms

Recursive bilinear algorithms use a divide-and-conquer strategy. They utilize a fixed-size base case, allowing fast computation of small inputs. Recursive-bilinear algorithms representing matrix multiplication are denoted by their base case using the following notation.

As noted above, a recursive-bilinear matrix multiplication algorithm with a base case that multiplies matrices of dimension n×m and m×k using t scalar multiplications, is denoted by [symbol] n, m, k; t [symbol] .

Any such algorithm can be naturally extended into a recursive-bilinear algorithm which multiplies matrices of dimensions n^{l}×m^{l}, m^{l}×k^{l}, where l∈ [symbol] . The input matrices are first segmented into blocks of sizes

$$\frac{{n}^{l}}{n} \times \frac{{m}^{l}}{m} , \frac{{m}^{l}}{m} \times \frac{{k}^{l}}{k} ,$$

respectively. Subsequently, linear combinations of blocks are performed directly, while scalar multiplication of blocks is computed via recursive invocations of the base algorithm. Once the blocks are decomposed into single scalars, multiplication is performed directly.

The asymptotic complexity of an [symbol] n, n, n; t [symbol] -algorithm is O(n^{ω}^{₀}), where ω₀=logₙ(t). In the rectangular case, the exponent of an [symbol] n, m, k; t [symbol] -algorithm is ω₀=logₙₘₖ(t³).

Any bilinear algorithm, matrix multiplication included, can be described using three matrices, in the following form:
Bilinear Representation: Let R be a ring, and let n, m, k∈ [symbol] . Let f(x, y): (R^{n·m}×R^{m·k})→R^{n·k} be a bilinear algorithm that performs t multiplications. There exist three matrices: U∈R^{t×n·m}, V∈R^{t×m·k}, W∈R^{t×n·k}, such that:

∀x∈R^{n×m}, y∈R^{m×k}: f(x, y)=W^{T}((U·\vec{x})⊙(V·\vec{y})) Where ⊙istheHadamard(element−wise)product.

Let R be a ring, and let U∈R^{t×nm}, V∈R^{t×mk}, W∈R^{t×nk} be three matrices. A recursive-bilinear algorithm with the encoding matrices U, V and the decoding matrix W, is defined as follows:

Algorithm 1: Recursive-Bilinear Algorithm [symbol]
Input: a ∈ R^{(nm)}^{^{l}}, b ∈ R^{(mk)}^{^{l}}
Output: c = [symbol] (a,b)

| | |
|---|---|
| 1: | procedure [symbol] (a, b) |
| 2: | ã = U · â >Transform inputs |
| 3: | \tilde{b} = V · \hat{b} |
| 4: | if l = 1 then >Base Case |
| 5: | \tilde{c} = W^{T} · (ã ⊙ \tilde{b}) >Scalar multiplication |
| 6: | else |
| 7: | for r = 1 to t do |
| 8: | \tilde{c}[r] = [symbol] (ã[r], \tilde{b}[r]) >Recursion |
| 9: | return W^{T} · \tilde{c} |

A recursive-bilinear algorithm defined by the matrices U,V,W is denoted by [symbol] .

The following necessary and sufficient condition characterizes the encoding and decoding matrices of matrix multiplication algorithms:
Triple Product Condition: Let R be a ring and let m, n, k, t∈ [symbol] . Let U∈R^{t×nm}, V∈R^{t×mk}, W∈R^{t×nk}. For every r∈[t], denote U_{r,(i,j)} the element in the r'th row of U corresponding to the input element A_{i,j}. Similarly, V_{r,(i,j)} corresponds to the input element B_{i,j}, and W_{r,(i,j)} to the output element (AB)_{i,j}. U,V are the encoding matrices and W is the decoding matrix of an (n, m, k; t)-algorithm if and only if:

∀i₁, i₂Σ[n], ∀k₁, k₂Σ[m], ∀j₁, j₂Σ[k]Σᵣ₌₁^{t}U_{r,(i}_{₁}_{,k}_{₁}₎V_{r,(k}_{₂}_{,j}_{₁}₎W_{r,(i}_{₂}_{,j}_{₂}₎=δᵢ_{₁}_{,i}_{₂}δₖ_{₁}_{,k}_{₂}δⱼ_{₁}_{,j}_{₂} Whereδ_{i,j}=1⇔i=j
Additive Complexity: Encoding the inputs and decoding the outputs of an [symbol] n, m, k; t [symbol] -algorithm using the corresponding encoding/decoding matrices U, V, W incurs an arithmetic cost. Let qᵤ, qᵥ, q_{w} be the number of arithmetic operations performed by the encoding and decoding matrices, correspondingly. Then:

qᵤ=nnz(U)+nns(U)−rows(U)

qᵥ=nnz(V)+nns(V)−rows(V)

q_{w}=nnz(W)+nns(W)−cols(W)
Proof: Each row of U, V corresponds to a linear combination of A,B's elements. Each column of W corresponds to combinations of the multiplicands. The first non-zero entry in each row selects the first element to include in the combination (at no arithmetic cost). Each additional non-zero element indicates another element in the combination, requiring an additional arithmetic operation. If the entry is not a singleton, it requires an additional multiplication by a scalar, thus requiring two operations in total.

### DECOMPOSED RECURSIVE-BILINEAR ALGORITHM

### Fast Recursive Transformation

As noted herein, the additive complexities qᵤ,qᵥ,q_{w} are determined by the amount of non-zeros and non-singletons in the matrices U,V,W. Thus, sparsifying these matrices accelerates their corresponding algorithms. To this end, a set of efficiently computable recursive transformations are now defined which will later be leveraged to increase the sparsity of the encoding/decoding matrices.

Generalization of Karstadt and Schwartz (2017): Let R be a ring. Let φ₁:R^{s}^{₁}→R^{s}^{₂} be a linear transformation. Let l∈ [symbol] and denote S₁=(s₁)^{l}, S₂=(s₂)^{l}. Let v∈R^{s}^{₁}, and denote

$$∀ i ∈ [ {s}_{1} ] : {v}^{( i )} = ( {v}_{\frac{{s}_{1}}{{s}_{1}} \cdot ( i - 1 ) + 1} , … , {v}_{\frac{{s}_{1}}{{s}_{1}} \cdot i} ) .$$

The linear map φₗ:R^{s}^{₁}→R^{s}^{₂} is recursively-defined as follows:

$${φ}_{l} ( v ) = {φ}_{1} ( \begin{matrix}{φ}_{l - 1} ( {v}^{( 1 )} ) \\ {φ}_{l - 1} ( {v}^{( 2 )} ) \\ ⋮ \\ {φ}_{l - 1} ( {v}^{( {s}_{1} )} )\end{matrix} )$$

where φ₁ is applied to a vector of s₁ elements in

$${R}^{\frac{{S}_{1}}{{s}_{1}}} .$$

Applying the recursively-defined φₗ to the block-row order vectorization of a matrix A∈R^{N×M} yields:

$${φ}_{l} ( \vec{A} ) = {φ}_{1} ( \overleftarrow{( \begin{matrix}{φ}_{l - 1} ( {\vec{A}}_{1 , 1} ) & … & {φ}_{l - 1} ( {\vec{A}}_{1 , m} ) \\ ⋮ & ⋱ & ⋮ \\ {φ}_{l - 1} ( {\vec{A}}_{n , 1} ) & … & {φ}_{l - 1} ( {\vec{A}}_{n , m} )\end{matrix} )} )$$

### Analysis of Recursive-Bilinear Algorithms

Mixed-Product Property: Denote by ⊗ the Kronecker product. Let A, B∈R^{m}^{₁}^{×n}^{₁} and C, D∈R^{m}^{₂}^{×n}^{₂} be two matrices. The following equality holds:

(A⊗B)(C⊗D)=(AC)⊗(BD)

Let R be a ring. Let φ₁:R^{s}^{₁}=→R^{s}^{₂} be a linear transformation. Let l∈ [symbol] and denote S₁=(s₁)^{l}, S₂=(s₂)^{l}. Let v∈R^{s}^{₁}. Denote by ⊗ the Kronecker product. Then:

$${φ}_{l} ( \vec{v} ) = {\underbrace{( {φ}_{1} ⊗ … ⊗ {φ}_{1} )}}_{l times} \cdot \vec{v} = ( {⊗}_{l} {φ}_{1} ) \cdot \vec{v}$$

Proof: The proof is by induction on l. The base case (l=1) is immediate, since:

φ₁(\vec{v})=(⊗₁φ₁)\vec{v}

Next it is assumed the claim holds for (l−1)∈ [symbol] and the fact that it holds for l is shown.

$$\begin{matrix}{φ}_{l} ( \vec{v} ) = {{φ}_{1} ( {φ}_{l - 1} ( {v}^{( 1 )} ) , {φ}_{l - 1} ( {v}^{( 2 )} ) , … , {φ}_{l - 1} ( {v}^{( {s}_{1} )} ) )}^{T} \\ = {{φ}_{1} ( ( {⊗}_{l - 1} {φ}_{1} ) {v}^{( 1 )} , ( {⊗}_{l - 1} {φ}_{1} ) {v}^{( 2 )} , … , ( {⊗}_{l - 1} {φ}_{1} ) {v}^{( {s}_{1} )} )}^{T} \\ = ( {φ}_{1} ⊗ {φ}_{1 - 1} ) \cdot \vec{v} = ( {⊗}_{l} {φ}_{1} ) \cdot \vec{v}\end{matrix}$$

where the first equality is by the definition of φₗ, the second is by the induction hypothesis, and the last equality is by the definition of the Kronecker product.

Let R be a ring. Let U∈R^{t×nm}, V∈R^{t×mk}, W∈R^{t×nk} be three matrices and let [symbol] be a recursive-bilinear algorithm defined by U,V,W. Let l∈ [symbol] and denote N=n^{l}, M=m^{l}, K=k^{l}. Let a∈R^{NM} and b∈R^{MK} be two vectors. Then:

$${ALG}_{〈 U , V , W 〉} ( a , b ) = {W}_{l}^{T} \cdot ( ( {U}_{l} \cdot a ) ⊙ ( {V}_{l} \cdot b ) )$$

Proof: The proof is by induction on l. The base case (l=1) is immediate, since by definition of a recursive-bilinear algorithm, ∀x∈R^{nm}, ∀y∈R^{mk}:

$${ALG}_{〈 U , V , W 〉} ( x , y ) = {W}^{T} \cdot ( ( U \cdot x ) ( V \cdot y ) ) = {W}_{1}^{T} \cdot ( ( {U}_{1} \cdot x ) ⊙ ( {V}_{1} \cdot y ) )$$

Next it is assumed the claim holds for (l−1)∈ [symbol] and that fact that it holds for l is shown. Denote â, \hat{b} the block segmentations of a and b, respectively. Let:

$$∀ i ∈ [ t ] : {c}_{i} = {ALG}_{〈 U , V , W 〉} ( {( U \cdot \hat{a} )}_{i} , {( V \cdot \hat{b} )}_{i} )$$

By the induction hypothesis:

$${c}_{i} = {W}_{l - 1}^{T} \cdot ( ( {U}_{l - 1} \cdot {( U \cdot \hat{a} )}_{i} ) ⊙ ( {V}_{l - 1} \cdot {( V \cdot \hat{b} )}_{i} ) )$$

However:

$$( \begin{matrix}{U}_{l - 1} \cdot {( U \cdot \hat{a} )}_{1} \\ ⋮ \\ {U}_{l - 1} \cdot {( U \cdot \hat{a} )}_{t}\end{matrix} ) = {( \begin{matrix}{u}_{1 , 1} \cdot {U}_{l - 1} & … & {u}_{1 , nm} \cdot {U}_{l - 1} \\ ⋮ & ⋱ & ⋮ \\ {u}_{t , 1} \cdot {U}_{l - 1} & … & {u}_{t , nm} \cdot {U}_{l - 1}\end{matrix} )}_{i} \cdot \hat{a} = {U}_{l} \cdot a$$

where the last equality follows as shown herein. The same applies to V. Therefore by the definition of [symbol] :

$$\begin{matrix}{ALG}_{〈 U , V , W 〉} ( a , b ) = {W}^{T} \cdot {( {c}_{1} … {c}_{t} )}^{T} \\ = {W}^{T} \cdot ( \begin{matrix}{W}_{l - 1}^{T} \cdot ( ( {U}_{l - 1} \cdot {( U \cdot \hat{a} )}_{i} ) ⊙ ( {V}_{l - 1} \cdot {( V \cdot \hat{b} )}_{i} ) \\ ⋮ \\ {W}_{l - 1}^{T} \cdot ( ( {U}_{l - 1} \cdot {( U \cdot \hat{a} )}_{t} ) ⊙ ( {V}_{l - 1} \cdot {( V \cdot \hat{b} )}_{t} )\end{matrix} ) \\ = {W}_{l}^{T} ( ( {U}_{l} \cdot a ) ⊙ ( {V}_{l} \cdot b ) )\end{matrix}$$

where the last equality follows as shown herein.

### Decomposed Bilinear Algorithm

Let U, V and W be the encoding/decoding matrices of a recursive-bilinear algorithm. Let U=U_{φ}·φ, V=V_{ψ}·ψ and W=Wτ·τ be decompositions of the aforementioned matrices, and let [symbol] be a recursive-bilinear algorithm defined by the encoding and decoding matrices U_{φ}, V_{ψ}, and W_{τ}. Let l∈ [symbol] and denote N=n^{l}, M=m^{l}. The Decomposed Recursive-Bilinear Algorithm is defined as follows:

Algorithm 2: Decomposed Recursive-Bilinear Algorithm
Input: a ∈ R^{N}, b ∈ R^{M}
Output: c = [symbol] (a, b)
1: function DRB(a, b)
2: ã = φₗ (a) >Transform the first input
3: \tilde{b} = ψₗ (b) >Transform the second input
4: \tilde{c} = [symbol] (ã, \tilde{b}) >Recursive-bilinear phase
5: \tilde{c} = τₗ^{T} (\tilde{c}) >Transform the output
6: return c

### Correctness

In this section, it is proven that output of the Decomposed Recursive-Bilinear Algorithm (DRB) is identical to the output of a recursive-bilinear algorithm with the encoding and decoding matrices U, V and W.

Let U∈R^{t×nm}, V∈R^{t×mk}, W∈R^{t×nk} be three matrices. Let:

U_{φ}∈R^{t×(t-r}^{ᵤ}⁾φ∈R^{(t-r}^{ᵤ}^{)×nm}rᵤ∈[t−nm]

V_{ψ}∈R^{t×(t-r}^{ᵥ}⁾ψ∈R^{(t-r}^{ᵥ}^{)×mk}rᵥ∈[t−mk]

W_{τ}∈R^{t×(t-r}^{_{w}}⁾τ∈R^{(t-r}^{_{w}}^{)×nk}r_{w}∈[t−nk]

where U=U_{φ}·φ, V=V_{ψ}·ψ and W=Wτ·τ. The term U_{φ}, V_{ψ}, W_{τ}, φ, ψ, τ is referred to as a decomposition of U, V, and W with levels rᵤ, rᵥ, and r_{w}, correspondingly.

Let R be a ring. Let l∈ [symbol] and denote N=n^{l}, M=m^{l}, K=k^{l}. Let a∈R^{NM}, b∈R^{MK} be two vectors. Let U∈R^{t×nm}, V∈R^{t×mk}, and W∈R^{t×nk} be three matrices, and let U_{φ}, V_{ψ}, W_{τ}, φ, ψ, τ be a decomposition of U, V, W with levels rᵤ, rᵥ,r_{w}. Let [symbol] be a recursive-bilinear algorithm defined by U_{φ}, V_{ψ}, W_{τ}, and denote ã=φₗ(a), \tilde{b}=ψₗ(b). The following equality holds:

$${ALG}_{〈 {U}_{φ} , {V}_{ψ} , {W}_{τ} 〉} ( \tilde{a} , \tilde{b} ) = {W}_{{τ}_{l}}^{T} \cdot ( ( {U}_{l} \cdot a ) ⊙ ( {V}_{l} \cdot b ) )$$

Proof: [symbol] is a recursive-bilinear algorithm which uses the encoding/decoding matrices U_{φ}, V_{ψ}, W_{τ}, therefore as above, ∀x∈R^{NM}, ∀y∈R^{MK}:

$${ALG}_{〈 {U}_{φ} , {V}_{ψ} , {W}_{τ} 〉} ( x , y ) = {W}_{{τ}_{l}}^{T} ( ( {U}_{{φ}_{l}} \cdot x ) ⊙ ( {V}_{{ψ}_{l}} \cdot y ) )$$

Observe the following equality:

$$\begin{matrix}{U}_{{φ}_{l}} \cdot {φ}_{l} = ( {U}_{φ} ⊗ {U}_{{φ}_{l - 1}} ) \cdot ( φ ⊗ {φ}_{l - 1} ) ) \\ = ( {U}_{φ} φ ) ⊗ ( {U}_{{φ}_{l - 1}} {φ}_{l - 1} ) \\ = U ⊗ ( {U}_{{φ}_{l - 1}} {φ}_{l - 1} ) \\ = U ⊗ … ⊗ U = {U}_{l}\end{matrix}$$

Similarly, V_{ψ}_{ₗ}·ψₗ=Vₗ and W_{τ}_{ₗ}·τₗ=Wₗ. Therefore, applying [symbol] to ã, \tilde{b} yields:

$$\begin{matrix}{ALG}_{〈 {U}_{φ} , {V}_{ψ} , {W}_{τ} 〉} = {W}_{{τ}_{l}}^{T} ( ( {U}_{{φ}_{l}} \cdot \tilde{a} ) ⊙ ( {V}_{{ψ}_{l}} \cdot \tilde{b} ) ) \\ = {W}_{{τ}_{l}}^{T} ( ( {U}_{{φ}_{l}} \cdot {φ}_{1} \cdot a ) ⊙ ( {V}_{{ψ}_{l}} \cdot {ψ}_{l} \cdot b ) ) \\ = {W}_{{τ}_{l}}^{T} ( ( ( {U}_{{φ}_{l}} \cdot {φ}_{l} ) \cdot a ) ⊙ ( ( {V}_{{ψ}_{l}} \cdot {ψ}_{l} ) \cdot b ) ) \\ = {W}_{{τ}_{l}}^{T} \cdot ( ( {U}_{l} \cdot a ) ⊙ ( {V}_{l} \cdot b ) )\end{matrix}$$

Let R be a ring. Let l∈ [symbol] and denote N =n^{l}, M=m^{l}, K=k^{l}. Let U∈R^{t×nm}, V∈R^{t×mk}, W∈R^{t×nk} be three matrices, and let U_{φ}, V_{ψ}, W_{τ}, φ, ψ, τ be a decomposition of U, V, W with levels rᵤ, r_{y}, r_{w}. Let DRB be defined as above, and let [symbol] , [symbol] be recursive-bilinear algorithms. The output of DRB satisfies:

∀a∈R^{NM}, ∀b∈R^{MK}:DRB(a, b)= [symbol]
Proof: Denote ã=φₗ(a), \tilde{b}=ψₗ(b). As above:

[symbol]

(ã, \tilde{b})=W_{τ}_{ₗ}^{T}((Uₗ·a)⊙(Vₗ·b))

Therefore by the definition of DRB:

$$\begin{matrix}DRB ( a , b ) = {τ}_{l}^{T} \cdot {ALG}_{〈 {U}_{φ} , {V}_{ψ} {W}_{τ} 〉} \\ = {τ}_{l}^{T} \cdot {W}_{{τ}_{l}}^{T} \cdot ( ( {U}_{l} \cdot a ) ⊙ ( {V}_{l} \cdot b ) ) \\ = {( {W}_{{τ}_{l}} \cdot {τ}_{l} )}^{T} \cdot ( ( {U}_{l} \cdot a ) ⊙ ( {V}_{l} \cdot b ) ) \\ = {W}_{l}^{T} \cdot ( ( {U}_{l} \cdot a ) ⊙ ( {V}_{l} \cdot b ) )\end{matrix}$$

where the second equality follows from above and the fourth equality follows from the identity W_{τ}_{ₗ}·τₗ=Wₗ above.

Let U, V and W be the encoding and decoding matrices of an [symbol] n, m, k; t [symbol] -algorithm. Then ∀A∈Rⁿ^{^{l}}^{×m}^{^{l}}, ∀B∈R^{m}^{^{l}}^{×k}^{^{l}}:

$$DRB ( \vec{A} , \vec{B} ) = {ALG}_{〈 U , V , W 〉} ( \vec{A} , \vec{B} ) = \overleftarrow{A \cdot B}$$

### Arithmetic Complexity

The arithmetic complexity of an algorithm was analyzed. To this end, the arithmetic complexity of an [symbol] n, m, k; t [symbol] -algorithm was first computed.

Let R be a ring and let ALG be a recursive-bilinear [symbol] n, m, k; t [symbol] -algorithm. Let l∈ [symbol] and denote N=n^{l}, M=m^{l}, K=k^{l}. Let A∈R^{N×M}, B∈R^{M×K} be two matrices. Let qᵤ,qᵥ,q_{w} be the additive complexities of the encoding/decoding matrices. The arithmetic complexity of ALG(A, B) is:

$${F}_{ALG} ( N , M , K ) = ( \frac{{q}_{u}}{t - nm} + \frac{{q}_{v}}{t - mk} + \frac{{q}_{w}}{t - nk} + 1 ) \cdot {t}^{l} - \frac{{q}_{u}}{t - nm} \cdot NM - \frac{{q}_{v}}{t - mk} \cdot MK - \frac{{q}_{w}}{t - nk} \cdot NK$$

Proof. ALG is a recursive algorithm. In each step, ALG invokes t recursive calls on blocks of size

$$\frac{N}{n} \times \frac{M}{m} and \frac{M}{m} \times \frac{K}{k} .$$

During the encoding phase, ALG performs qᵤ arithmetic operations on blocks of size

$$\frac{N M}{n m}$$

and qᵥ operations on blocks of size

$$\frac{MK}{mk} .$$

During the decoding phase, q_{w} arithmetic operations are performed on blocks of size

$$\frac{NK}{nk} .$$

### Therefore:

$${F}_{ALG} ( N , M , K ) = t \cdot {F}_{ALG} ( \frac{N}{n} , \frac{M}{m} , \frac{K}{k} ) + {q}_{u} \cdot ( \frac{NM}{n m} ) + {q}_{v} \cdot ( \frac{MK}{m k} ) + {q}_{w} \cdot ( \frac{NK}{n k} )$$

Moreover, F_{ALG}(1,1,1)=1 since multiplying two scalar values requires a single arithmetic operation. Thus:

$${F}_{A L G} ( N , M , K )$$

$$\begin{matrix}= t \cdot {F}_{A L G} ( \frac{N}{n} , \frac{M}{m} , \frac{K}{k} ) + {q}_{u} \cdot ( \frac{NM}{n m} ) + {q}_{v} \cdot ( \frac{MK}{m k} ) + {q}_{w} \cdot ( \frac{NK}{n k} ) \\ = {Σ}_{r = 0}^{l - 1} ( ( \frac{{q}_{u} N M}{{( n m )}^{r + 1}} + \frac{{q}_{v} M K}{{( m k )}^{r + 1}} + \frac{{q}_{w} N K}{{( n k )}^{r + 1}} ) {t}^{r} ) + {t}^{l} \cdot {F}_{A L G} ( 1 , 1 , 1 ) \\ = \frac{{q}_{u} N M}{n m} {Σ}_{r = 0}^{l - 1} ( \frac{t}{n m} ) + \frac{{q}_{v} M K}{m k} {Σ}_{r = 0}^{l - 1} ( \frac{t}{m k} ) + \frac{{q}_{w} N K}{n k} {Σ}_{r = 0}^{l - 1} ( \frac{t}{n k} ) + {t}^{l} \\ = {q}_{u} \cdot \frac{{t}^{l} - NM}{t - nm} + {q}_{v} \cdot \frac{{t}^{l} - MK}{t - mk} {q}_{w} \frac{{t}^{l} - NK}{t - nk} + {t}^{l} \\ = ( \frac{{q}_{u}}{t - nm} + \frac{{q}_{v}}{t - mk} + \frac{{q}_{w}}{t - nk} + 1 ) \cdot {t}^{l}\end{matrix}$$

$$- \frac{{q}_{u}}{t - nm} \cdot NM - \frac{{q}_{v}}{t - mk} \cdot MK - \frac{{q}_{w}}{t - nk} \cdot NK$$

Denote q=qᵤ+qᵥ+q_{w}. The arithmetic complexity of an [symbol] n, n, n; t [symbol] -algorithm is:

$$( \frac{q}{t - {n}^{2}} + 1 ) {N}^{{log}_{n} ( t )} - \frac{q}{t - {n}^{2}} \cdot {N}^{2}$$

Proof: Observe that l=logₙ(N), thus t^{l}=N^{log}^{ₙ}^{(t)}. Substituting this equality as detail above, and letting N=M=K, yields the expression above.

Let R be a ring and let φ₁:R^{s}^{₁}→R^{s}^{₂} be a linear transformation, where s₁≠S₂. Denote by q_{φ} the additive complexity (as detail herein) of φ₁. Let l∈ [symbol] and denote S₁=(s₁)^{l}, S₂=(s₂)^{l}. Let v∈R^{s}^{₁} be a vector. The arithmetic complexity of computing φₗ(v) is:

$${F}_{φ} ( {S}_{1} ) = \frac{{q}_{φ}}{{s}_{1} - {s}_{2}} \cdot ( {S}_{1} - {S}_{2} )$$

Proof: φₗ(v) is computed recursively. In each recursive call, φ₁ is invoked on each of the s₁ blocks of v, whose sizes are

$$\frac{{S}_{1}}{{s}_{1}} .$$

In each call, φ₁ performs q_{φ} arithmetic operations on the resulting blocks, whose sizes are

$$\frac{{S}_{2}}{{s}_{2}} .$$

### Therefore:

$${F}_{φ} ( {S}_{1} ) = {s}_{1} \cdot {F}_{φ} ( \frac{{S}_{1}}{{s}_{1}} ) + {q}_{φ} \cdot \frac{{S}_{2}}{{s}_{2}}$$

Moreover, F_{φ}(1)=0 since handling a single scalar value requires no operations. Thus:

$$\begin{matrix}{F}_{φ} ( {S}_{1} ) = {{Σ}_{r = 0}^{l - 1} ( {s}_{1} )}^{r} \cdot {q}_{φ} \frac{{s}_{2}}{{( {s}_{2} )}^{r + 1}} \\ = {q}_{φ} \cdot \frac{{S}_{2}}{{s}_{2}} \cdot {{Σ}_{r = 0}^{l - 1} ( \frac{{s}_{1}}{{s}_{2}} )}^{r} \\ = \frac{{q}_{φ} \cdot {S}_{2}}{{s}_{2}} \cdot ( \frac{{s}_{1}}{{s}_{2}} - 1 ) \cdot \frac{{s}_{2}}{{s}_{1} - {s}_{2}} = \frac{{q}_{φ}}{{s}_{1} - {s}_{2}} \cdot ( {S}_{1} - {S}_{2} )\end{matrix}$$

The expression above holds for s₁≠S₂. If s₁=s₂ the complexity is:

$${F}_{φ} ( {S}_{1} ) = {{Σ}_{r = 0}^{l - 1} ( {s}_{1} )}^{r} \cdot {q}_{φ} \frac{{S}_{1}}{{( {s}_{1} )}^{r + 1}} = \frac{{q}_{φ}}{{s}_{1}} \cdot {S}_{1} \cdot {log}_{{s}_{1}} {S}_{1}$$

The arithmetic complexity incurred by the “core” of the algorithm; the recursive-bilinear [symbol] was computed:

Let R be a ring and let U,V and W be the matrices of an [symbol] n, m, k; t [symbol] -algorithm, where U∈R^{t×nm}, V∈R^{t×mk}, W∈R^{t×nk}, and let U_{φ}, V_{ψ}, W_{τ}, φ, ψ, τ be a decomposition of U, V, W with levels rᵤ,rᵥ,r_{w}, as above. Let qᵤ_{_{φ}}, qᵥ_{_{ψ}}, q_{w}_{_{τ}} be the additive complexities of U_{φ}, V_{ψ}, W_{τ}, correspondingly. Let l∈ [symbol] and denote (mᵤ, mᵥ, m_{w})=(t−rᵤ, t−rᵥ, t−r_{w}) and (Mᵤ, Mᵥ, M_{w})=(mᵤ^{l}, mᵥ^{l}, m_{w}^{l}). Similarly, denote (N, M, K)=(n^{l}, m^{l}, k^{l}). Let A∈R^{N×M}, B∈R^{M×K} and denote Ã=φₗ(A)∈R^{M}^{ᵤ}, \tilde{B}=ψₗ(B)∈R^{M}^{ᵥ}. Let [symbol] be a recursive-bilinear algorithm defined by the matrices U_{φ}, V_{ψ} and W_{τ}.

The arithmetic complexity of [symbol] (Ã, \tilde{B}) is:

$${F}_{A L G} ( {M}_{u} , {M}_{v} ) =$$

$$( \frac{{{q}_{u}}_{φ}}{{r}_{u}} + \frac{{{q}_{v}}_{ψ}}{{r}_{v}} + \frac{{{q}_{w}}_{τ}}{{r}_{w}} + 1 ) \cdot {t}^{l} - \frac{{{q}_{u}}_{φ}}{{r}_{u}} \cdot {M}_{u} - \frac{{{q}_{v}}_{ψ}}{{r}_{v}} \cdot {M}_{v} - \frac{{{q}_{w}}_{τ}}{{r}_{w}} \cdot {M}_{w}$$

Proof: [symbol] is a recursive algorithm. In each step, [symbol] performs t recursive cells (multiplications) of blocks of size

$$\frac{{M}_{u}}{{m}_{u}} , \frac{{M}_{v}}{{m}_{v}} ,$$

producing blocks of size

$$\frac{{M}_{w}}{{m}_{w}} .$$

Encoding U requires qᵤ_{_{φ}} arithmetic operations on blocks of size

$$\frac{{M}_{u}}{{m}_{u}} \cdot$$

Similarly encoding V requires qᵤ_{_{ψ}} arithmetic operations on blocks of size

$$\frac{{M}_{v}}{{m}_{v}} \cdot$$

Decoding the multiplicands requires q_{w}_{_{τ}} arithmetic operations on blocks of size

$$\frac{{M}_{w}}{{m}_{w}} \cdot$$

therefore:

$${F}_{A L G} ( {M}_{u} , {M}_{v} ) = t \cdot {F}_{A L G} ( \frac{{M}_{u}}{{m}_{u}} , \frac{{M}_{v}}{{m}_{v}} )$$

$$+ {q}_{{u}_{φ}} \cdot \frac{{M}_{u}}{{m}_{u}} + {q}_{{v}_{ψ}} \cdot \frac{{M}_{v}}{{m}_{v}} + {q}_{{w}_{τ}} \cdot \frac{{M}_{w}}{{m}_{w}}$$

Furthermore, observe that F_{ALG}(1,1)=1 since multiplying scalar values requires a single arithmetic operation. Therefore:

$${F}_{A L G} ( {M}_{u} , {M}_{v} ) = [ {Σ}_{r = 0}^{l - 1} ( {q}_{{u}_{φ}} \frac{{M}_{u}}{{m}_{u}^{r + 1}} + {q}_{{v}_{ψ}} \frac{{M}_{v}}{{m}_{v}^{r + 1}} + {q}_{{w}_{τ}} \frac{{M}_{w}}{{m}_{w}^{r + 1}} ) \cdot {t}^{r} ]$$

$$+ \frac{{q}_{{u}_{φ}} {M}_{u}}{{r}_{u}} ( \frac{{t}^{ι}}{{M}_{u}} - 1 ) + \frac{{q}_{{v}_{ψ}} {M}_{v}}{{r}_{v}} ( \frac{{t}^{ι}}{{M}_{v}} - 1 )$$

$$+ \frac{{q}_{{w}_{τ}} {M}_{w}}{{r}_{w}} ( \frac{{t}^{ι}}{{M}_{w}} - 1 ) + {t}^{l}$$

$$= ( \frac{{q}_{{u}_{φ}}}{{r}_{u}} + \frac{{q}_{{v}_{ψ}}}{{r}_{v}} + \frac{{q}_{{w}_{τ}}}{{r}_{w}} + 1 ) \cdot {t}^{l} - \frac{{q}_{{u}_{φ}}}{{r}_{u}} \cdot {M}_{u}$$

$$- \frac{{q}_{{v}_{ψ}}}{{r}_{v}} \cdot {M}_{v} - \frac{{q}_{{w}_{τ}}}{{r}_{w}} \cdot {M}_{w}$$

Let R be a ring. Let l∈ [symbol] and denote N=n^{l}, M=m^{l}, K=k^{l}. Let A∈R^{N×M}, B∈R^{M,K} be two matrices. Let DRB be as defined above, and let U_{φ}, V_{ψ}, W_{τ}, φ, ψ, τ be a decomposition of U, V, W with levels rᵤ,rᵥ,r_{w}, as above. Let [symbol] be a recursive-bilinear algorithm defined by the matrices U_{φ}, V_{ψ}, W_{τ}. The arithmetic complexity of DRB(A,B) is:

$${F}_{D R B} ( N , M , K ) = {F}_{φ} ( N M ) + {F}_{ψ} ( M K ) + {F}_{A L G} ( {M}_{u} , {M}_{v} ) + {F}_{τ} ( {M}_{w} )$$

$$= ( \frac{{q}_{{u}_{φ}}}{{r}_{u}} + \frac{{q}_{{v}_{ψ}}}{{r}_{v}} + \frac{{q}_{{w}_{τ}}}{{r}_{w}} + 1 ) \cdot {t}^{l}$$

$$+ ( \frac{{q}_{φ}}{t - {r}_{u} - n m} - \frac{{q}_{{u}_{φ}}}{{r}_{u}} ) \cdot {( t - {r}_{u} )}^{l}$$

$$+ ( \frac{q ψ}{r - {r}_{v} - m k} - \frac{{q}_{{v}_{ψ}}}{{r}_{v}} ) \cdot {( t - {r}_{v} )}^{l}$$

$$+ ( \frac{{q}_{τ}}{t - {r}_{w} - n k} - \frac{{q}_{{w}_{τ}}}{{r}_{w}} ) \cdot {( t - {r}_{w} )}^{l}$$

$$- \frac{{q}_{φ} \cdot NM}{t - {r}_{u} - n m} - \frac{{q}_{ψ} \cdot MK}{t - {r}_{v} - n m} - \frac{{q}_{τ} \cdot NK}{t - {r}_{w} - n m}$$

Proof: The arithmetic complexity was computed by adding up the complexities of each stage. Adding up all terms yields the expression above. The complexities of the two initial transformations φₗ(\vec{A}) and ψₗ(\vec{B}), and of the final transformation τₗ(\tilde{C}) are computed. Then the arithmetic complexity of [symbol] (Ã, \tilde{B}) is computed. Adding up all terms yields the expression above. The leading coefficient of DRB is:

$$\frac{{q}_{{u}_{φ}}}{{r}_{u}} + \frac{{q}_{{v}_{ψ}}}{{r}_{v}} + \frac{{q}_{{w}_{τ}}}{{r}_{w}} + 1$$

### IO-Complexity

The IO-Complexity of the fast recursive transformations was analyzed. The analysis corresponded to the sequential model with two memory levels, where the fast memory is of size M. In this model the IO complexity captured the number of transfers between the memory hierarchy, namely to and from the fast memory. Results of computations can be written out directly to the main memory without necessitating transfers from fast memory.

Let R be a ring, and let φ₁:R^{s}^{₁}→R^{s}^{₂} be a linear transformation. Denote by q_{φ} the additive complexity of φ₁. Let l∈ [symbol] and denote S₁=(s₁)^{l}, S₂=(s₂)^{l}. Let v∈R^{s}^{₁} be a vector. Let

$$f = {log}_{{s}_{1}} \frac{{s}_{1}}{\sqrt{\frac{M}{2}}} .$$

The IO-Complexity of computing φₗ(v) is:

$$I {0}_{φ} ( {S}_{1} , M ) = ( \frac{3 {q}_{φ}}{{s}_{1} - {s}_{2}} \cdot ( {( \frac{{s}_{1}}{{s}_{2}} )}^{f} - 1 ) ) \cdot {S}_{2} + ( 2 \cdot \frac{M + {( {s}_{2} )}^{f}}{M} ) \cdot {S}_{1}$$

Proof: The proof is similar to that of the arithmetic complexity, the main difference being the halting criteria and the complexity at the base-case. φₗ is computed recursively. At each step, φₗ₋₁ is applied s₁ times to vectors of size

$$\frac{{s}_{1}}{{s}_{1}} ,$$

producing vectors of size

$$\frac{{s}_{2}}{{s}_{2}} .$$

When 2S₁≤M, two input blocks fit inside the fast memory, requiring only M read operations, and the output is written out requiring S₂ writes. When the problem does not fit inside fast memory, each addition requires at most 3 data transfers: 2 reads for the inputs, and one write for the output. Therefore:

$$I {0}_{φ} ( {S}_{1} , M ) \leq ( \begin{matrix}{s}_{1} \cdot I {0}_{φ} ( \frac{{s}_{1}}{{s}_{1}} , M ) + 3 {q}_{φ} \cdot \frac{{s}_{2}}{{s}_{2}} \\ M + {S}_{2}\end{matrix} \begin{matrix}2 {S}_{1} > M \\ 2 {S}_{1} \leq M\end{matrix}$$

Solving the recurrence the following was obtained:

$$I {0}_{φ} ( {S}_{1} , M ) \leq {Σ}_{r = 0}^{f - 1} ( 3 {q}_{φ} \cdot \frac{{( {s}_{1} )}^{r}}{{( {s}_{2} )}^{l - r - 1}} ) + ( M + {( {s}_{2} )}^{f} ) \cdot \frac{2 {S}_{1}}{M}$$

$$= 3 {q}_{φ} \cdot {( {s}_{2} )}^{l - 1} {{Σ}_{r = 0}^{f - 1} ( \frac{{s}_{1}}{{s}_{2}} )}^{r} + ( M + {( {s}_{2} )}^{f} ) \cdot \frac{2 {S}_{1}}{M}$$

$$= ( \frac{3 {q}_{φ}}{{s}_{1} - {s}_{2}} \cdot ( {( \frac{{s}_{1}}{{s}_{2}} )}^{f} - 1 ) ) \cdot {S}_{2} + ( 2 \cdot \frac{M + {( {s}_{2} )}^{f}}{M} ) \cdot {S}_{1}$$

### Full Decomposition

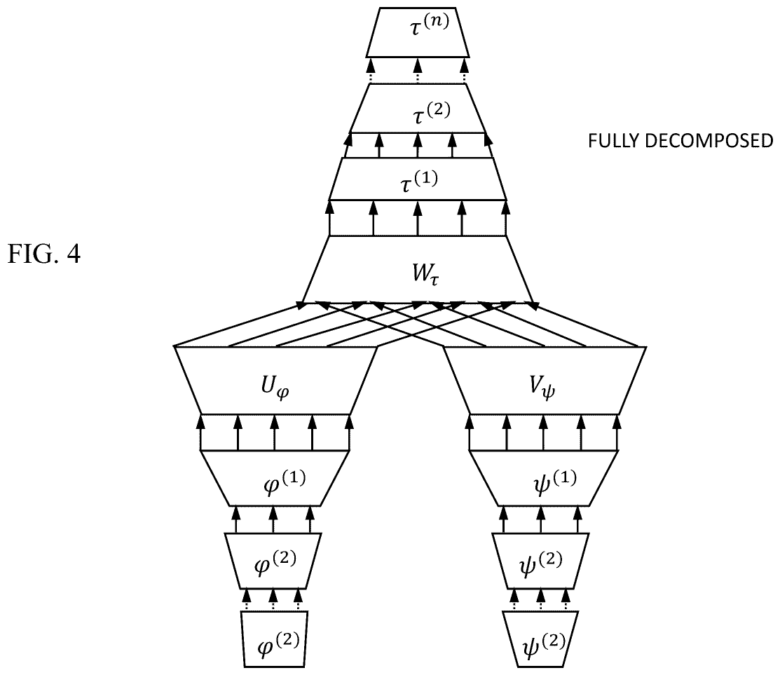

Above, a decomposition in which each of the encoding/decoding matrices of an [symbol] n, m, k; t [symbol] -algorithm is split into a pair of matrices was demonstrated. Such a decomposition is referred to as a first-order decomposition. First-order decompositions allowed a reduction of the leading coefficient, at the cost of introducing new low-order monomials. The same approach can then be repeatedly applied to the output of the decomposition, thus also reducing the coefficients of low-order monomials (see FIG. 4).

Let Q∈R^{t×s} be an encoding or decoding matrix of an [symbol] n, m, k; t [symbol] -algorithm. The c-order decomposition of Q is defined as:

$$Q = {Q}_{φ} \cdot {φ}^{( 1 )} \cdot {φ}^{( 2 )} \cdot … \cdot {φ}^{( c )} = {Q}_{φ} \cdot {Π}_{i = 1}^{c} {φ}^{( i )}$$

where φ⁽ⁱ⁾∈R^{h}^{ᵢ}^{×h}^{ᵢ₊₁}, and ∀i∈[c]:hᵢ>hᵢ₊₁. Furthermore, h_{c}=s. Interestingly, full decompositions may result in zero coefficients for some of the lower-order monomials. In the first-order decomposition, the decomposition level determines the degree of the lower-order monomial; higher decomposition levels yield lower-degree monomial incurred by the transformation cost. In a full decomposition, some lower-order monomials might cancel out altogether, as their transformation costs may cancel out some terms telescopically. See Table 1 below for an example of the full decomposition of the [symbol] 3,3,3; 23 [symbol] -algorithm.

TABLE 2
Example of Arithmetic Complexity: [symbol] 3, 3, 3 [symbol] -Algorithms

| ALGORITHM | ARITHMETIC COMPLEXITY |
|---|---|
| [symbol] 3,3,3; 27 [symbol] Classical | 2n³ − n² |
| [symbol] 3,3,3; 23 [symbol] Original Algorithm | 7.93n^{log}^{₃}²³ − 6.93n² |
| [symbol] 3,3,3; 23 [symbol] Alternative Basis | 5.36n^{log}^{₃}²³ + 3.22n²log₃n − 4.36n² |
| [symbol] 3,3,3; 23 [symbol] Decomposed | 2n^{log}^{₃}²³ + 6.75n^{log}^{₃}²¹ − 7.75n² |
| [symbol] 3,3,3; 23 [symbol] Fully Decomposed | 2n^{log}^{₃}²³ + 3n^{log}^{₃}²⁰ + 2n^{log}^{₃}¹⁴ + |
| | 2n^{log}^{₃}¹² + 2n^{log}^{₃}¹¹ + 33n^{log}^{₃}¹⁰ − 43n² |

### LOWER BOUNDS

### Optimal Decomposition

The matrices corresponding to several matrix multiplication algorithms were decomposed. Some algorithms exhibited an optimal decomposition, namely the leading coefficient of their arithmetic complexity is 2. This is optimal, as shown in the following claim:

Let U,V,W be the encoding/decoding matrices of an [symbol] n, m, k; t [symbol] -algorithm. W.l.o.g, none of U,V,W contain an all-zero row. The leading coefficient of the arithmetic complexity of DRB is at least 2.
Proof: Let U_{φ}, V₁₀₄ , W_{τ}, φ, ψ, τ be a decomposition of U, V, W with levels rᵤ,rᵥ,r_{w}. The additive complexities satisfy:

$${q}_{{u}_{φ}} = n n z ( {U}_{φ} ) + n n s ( {U}_{φ} ) - rows ( {U}_{φ} )$$

$${q}_{v ψ} = n n z ( {V}_{ψ} ) + n n s ( {V}_{ψ} ) - rows ( {V}_{ψ} )$$

$${q}_{{w}_{τ}} = n n z ( {W}_{τ} ) + n n s ( {W}_{τ} ) - cols ( {W}_{τ} )$$

As U,V,W do not have all-zero rows, neither can U_{φ}, V₁₀₄ , W_{τ}, . Consequently, U_{φ}, V₁₀₄ , W_{τ} all have at least one non-zero element in every row:

nnz(U₁₀₀ )≥rows(U_{φ})

nnz(V_{ψ})≥rows(V_{ψ})

nnz(W_{τ})≥rows(W_{τ})
Therefore:

qᵤ_{_{φ}}≥0,

qᵥ_{_{ψ}}≥0,

$${q}_{{w}_{τ}} = rows ( {W}_{τ} ) - cols ( {W}_{τ} ) = {r}_{w}$$

The proof now follows from above.

All classical multiplication algorithms optimally decompose. However, the leading coefficient of classical algorithms is already 2 without decompositions, the minimal leading coefficient. Therefore, their decomposition does not allow for any further acceleration.

A Lower-Bound on the Leading Coefficient of [symbol] 2,2,2; 7 [symbol] -Algorithms

It has been shown previously that 15 additions are necessary for any [symbol] 2,2,2; 7 [symbol] -algorithm, assuming the input and output are given in the standard basis. Karstadt and Schwartz (2017) proved a lower-bound of 12 arithmetic operations for any [symbol] 2,2,2; 7 [symbol] -algorithm, regardless of the input and output bases, thus showing their algorithm obtains the optimum.

In the decomposed matrix multiplication regime, the input and output are given in bases of a different dimension. This could have allowed for sidestepping the aforementioned lower bound, by requiring a smaller number of linear operations and thus, perhaps, a smaller leading coefficient. It is proven herein that this is not the case. It is proven that while 12 arithmetic operations are not required in this model (indeed 4 suffice), the leading coefficient of any [symbol] 2,2,2; 7 [symbol] -algorithm remains at least 5, regardless of the decomposition level used.

Let Q be an encoding/decoding matrix of a [symbol] 2,2,2; 7 [symbol] -algorithm. Q has no all-zero rows.
Proof: The minimal number of multiplications for any [symbol] 2,2,2 [symbol] -algorithm was shown to be 7. Assume towards a contradiction that Q is an encoding matrix with an all-zeros row. Thus, the corresponding multiplicand is zero, allowing the output to be computed using only 6 multiplications, in contradiction to the previous lower bound. Similarly, if Q is a decoding matrix with an all zeros row, the corresponding multiplicand would always be discarded, once again allowing 6 multiplications, in contradiction to the previous lower bound.

For example, Q_{φ} has no all-zero rows, since a zero row in Q_{φ} implies such a row in Q. Let Q be an encoding/decoding matrix of a [symbol] 2,2,2; 7 [symbol] -algorithm. Q has no duplicate rows. Q_{φ} has no duplicate rows, since duplicate rows in Q_{φ} imply duplicates in Q. Let ALG be a [symbol] 2,2,2; 7 [symbol] -algorithm. The leading coefficient of ALG is 5.
Proof: Let U, V, W∈R^{7×4} be the encoding/decoding matrices of ALG. Denote their decomposition as follows:

$${U}_{φ} ∈ {R}^{7 \times ( t - {r}_{u} )} φ ∈ {R}^{( 7 - {r}_{u} ) \times 4} {r}_{u} ∈ [ 3 ] \\ {V}_{ψ} ∈ {R}^{7 \times ( t - {r}_{v} )} ψ ∈ {R}^{( 7 - {r}_{v} ) \times 4} {r}_{v} ∈ [ 3 ] \\ {W}_{τ} ∈ {R}^{7 \times ( t - {r}_{w} )} τ ∈ {R}^{( 7 - {r}_{w} ) \times 4} {r}_{w} ∈ [ 3 ]$$

For r=3, the matrices φ, ψ, τ are square, therefore this case is identical to the Alternative Basis model, in which each encoding/decoding matrix must have at-least 10 non-zero elements, therefore:

$$\begin{matrix}{q}_{{u}_{φ}} = nnz ( {U}_{φ} ) - rows ( {U}_{φ} ) \geq 10 - 7 = 3 \\ {q}_{{v}_{ψ}} = nnz ( {V}_{ψ} ) - rows ( {V}_{ψ} ) \geq 10 - 7 = 3 \\ {q}_{{w}_{τ}} = nnz ( {W}_{τ} ) - cols ( {W}_{τ} ) \geq 10 - 4 = 6\end{matrix}$$

Next, the decomposition level r=2 is handled. Let Q be an encoding/decoding matrix of a [symbol] 2,2,2; 7 [symbol] -algorithm, and let Q=Q_{φ}·φ, where Q_{φ∈R}^{7×5}, φ∈R^{5×4}. Each of Qφ's rows contain at least a single non-zero element. However, there are at most 5 such rows, therefore the remaining two rows must contain at-least two non-zero elements. Consequently:

$$nnz ( {Q}_{φ} ) \geq 5 + 2 + 2 = 9$$

Thus, the corresponding additive complexities satisfy:

$$\begin{matrix}{q}_{{u}_{φ}} = nnz ( {U}_{φ} ) - rows ( {U}_{φ} ) \geq 9 - 7 = 2 \\ {q}_{{v}_{ψ}} = nnz ( {V}_{ψ} ) - rows ( {V}_{ψ} ) \geq 9 - 7 = 2 \\ {q}_{{w}_{τ}} = nnz ( {W}_{τ} ) - cols ( {W}_{τ} ) \geq 9 - 5 = 4\end{matrix}$$

Lastly, the decomposition level r=1 is handled. Let Q be an encoding/decoding matrix of a [symbol] 2,2,2; 7 [symbol] -algorithm. Q=Q_{φ}·φ, where Q_{φ}∈R^{7×6}, φ∈R^{6×4}. Once again, Q_{φ} has no duplicate rows, and at least one non-zero element in each row. Therefore, 6 of Q_{φ}'s rows have at least one non-zero element, and the remaining row must contain at least 2 non-zeros. Therefore (Q_{φ})≥8, and:

$$\begin{matrix}{q}_{{u}_{φ}} = nnz ( {U}_{φ} ) - rows ( {U}_{φ} ) \geq 8 - 7 = 1 \\ {q}_{{v}_{ψ}} = nnz ( {V}_{ψ} ) - rows ( {V}_{ψ} ) \geq 8 - 7 = 1 \\ {q}_{{w}_{τ}} = nnz ( {W}_{τ} ) - cols ( {W}_{τ} ) \geq 8 - 6 = 2\end{matrix}$$

Putting the above terms together, it is observed that irrespective of the decomposition dimension, the arithmetic costs satisfy:

$$\begin{matrix}cost ( {U}_{φ} ) = \frac{{q}_{{u}_{φ}}}{{r}_{u}} {=}_{{r}_{u} = 3} \frac{3}{3} {=}_{{r}_{u} = 2} \frac{2}{2} {=}_{{r}_{u} = 1} \frac{1}{1} = 1 \\ cost ( {V}_{ψ} ) = \frac{{q}_{{v}_{ψ}}}{{r}_{v}} {=}_{{r}_{v} = 3} \frac{3}{3} {=}_{{r}_{v} = 2} \frac{2}{2} {=}_{{r}_{v} = 1} \frac{1}{1} = 1 \\ cost ( {W}_{τ} ) = \frac{{q}_{{w}_{τ}}}{{r}_{w}} {=}_{{r}_{w} = 3} \frac{6}{3} {=}_{{r}_{w} = 2} \frac{4}{2} {=}_{{r}_{w} = 1} \frac{2}{1} = 2\end{matrix}$$

Thus, in all cases the leading coefficient is:

$$cost ( {U}_{φ} ) + cost ( {V}_{ψ} ) + cost ( {W}_{τ} ) + 1 = 5$$

### Finding Sparse Decompositions

As the additive complexity of an [symbol] n, m, k; t [symbol] -algorithm is determined by the number of non-zero and non-singleton elements in its encoding/decoding matrices, sparse decompositions of the aforementioned matrices were wanted, preferably containing only singletons.

Formally, let Q∈R^{t×n} be an encoding or decoding matrix, and let r∈[t−n]. A decomposition of Q into Q_{φ}∈R^{t×(t-r)}, φ∈R^{(t-r)×n} was wanted, satisfying:

minimize: nnz(Q_{φ})+nns(Q_{φ})

subject to: Q=Q_{φ}·φ

This work focused on minimizing non-zeros, for two main reasons. First, many encoding/decoding matrices contain only singleton values, and moreover the resulting decompositions had only singletons. Furthermore, minimizing the number of non-zeros also bounds the number of non-singletons, as (A)≤(A).

The optimization problem above whose objective is minimizing only the number of non-zeros is known as the Dictionary Learning problem, which is NP-Hard and hard to approximate within a factor of 2^{log}^{^{1−∈}}^{m}, ∀∈>0 (unless NP⊆DTIME(m^{poly(log m)})). Nevertheless, due to the relatively small dimensions of many practical [symbol] n, m, k; t [symbol] -algorithm base cases, the aforementioned problem can feasibly be tackled with currently available computational power.

Let Q be an encoding or decoding matrix of an [symbol] n, m, k; t [symbol] -algorithm, and let r∈ [symbol] be the level decomposition wanted for Q. If Q has no all-zero rows, then Q_{φ} has non-zeros in every row and every column.
Proof: If Q does not contain zero rows, neither does Q_{φ}. Assume towards a contradiction there exists an all-zero column in Q_{φ}. Then an r−1 decomposition is implied, since:

$${iU}_{φ}^{′} 0 {U}_{φ}^{″} ccc ( ccc ) {φ}^{′} {v}_{i} {φ}^{″} = ( \begin{matrix}{U}_{φ}^{′} & {U}_{φ}^{″}\end{matrix} ) ( \begin{matrix}{φ}^{′} \\ {φ}^{″}\end{matrix} )$$

Thus Q_{φ} has non-zeros in every row and every column.

The sparsest structure with non-zeros in every row and every column is a (possibly permuted) diagonal matrix D₍ₜ₋ᵣ₎. Since the goal is to minimize both the number of non-zeros and the number of non-singletons, it is assumed Q_{φ} contains a (possibly permuted) identity matrix. Let P_{π} be the permutation matrix which permutes Q_{φ}'s rows such that the first t−r rows contain the identity matrix. Then multiplying by P_{π}:

$${P}_{π} \cdot Q = {P}_{π} \cdot {Q}_{φ} \cdot φ = ( \begin{matrix}1 & & \\ & ⋱ & \\ & & 1 \\ & … & \end{matrix} ) \cdot φ$$

Thus ∀i∈[t−r]:φᵢ=(P_{π}·Q)ᵢ, and therefore φ is uniquely determined by the location of the identity matrix's rows. Put together, the sparsification process works as follows:
(i) Choose the location of the identity matrix rows in Q_{φ}
(ii) Compute φ based on the above selection
(iii) For every remaining row of vᵢ of Q_{φ}, solve:

$${v}_{i} = {arg min}_{\vec{x} ∈ {R}^{t - r}} ( \{ nnz ( \vec{x} ) : {φ}^{T} \cdot {x}^{T} = {( {Q}_{i} )}^{T} \} )$$

The latter optimization problem is known as the Compressed Sensing problem. Nevertheless, many algorithms attempt to solve relaxations of the above problem. While these algorithms' optimization goals are different to that of Compressed Sensing, their outputs may converge under some conditions (i.e., the null-space property).

Due to the relatively small dimensions of the encoding/decoding matrices, all possible placements of non-zero elements in \vec{x} were iterated through, solving the corresponding least-squares instance for each such choice. This approach, while far slower than the aforementioned algorithms, resulted in far sparser solutions, as quite large portions of the solution-space were enumerated.

The present invention for reducing the hidden constant of the arithmetic complexity of fast matrix multiplication utilizes a richer set of decompositions, allowing for even faster practical algorithms. The present invention has the same asymptotic complexity of the original fast matrix multiplication algorithms, while significantly improving their leading coefficients.

Highly optimized implementations of the “classical” algorithm often outperform fast matrix multiplication algorithms for sufficiently small matrices. The present invention obtains fast matrix multiplication algorithms whose leading coefficients match that of the classical algorithm and may therefore outperform the classical algorithm even for relatively small matrices.

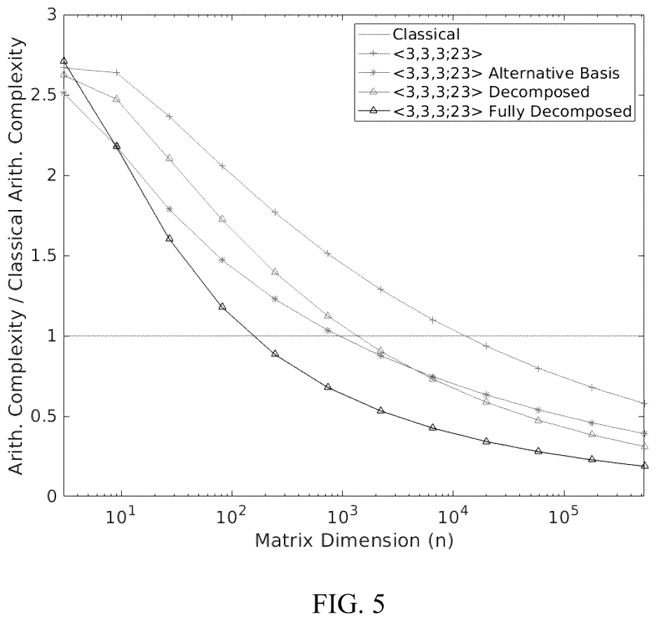

Iteratively applying the decomposition scheme allows for the reduction of the coefficients of lower-order monomials. For algorithms in which the degrees of lower-order monomials are quite close to that of the leading monomial, this further optimization can significantly improve the arithmetic complexity (see FIG. 5).

The algorithm of the present invention relies on a recursive divide-and-conquer strategy. Thus, the straight-forward serial recursive implementation matches the communication cost lower-bounds. For parallel implementations, the BFS-DFS method can be used to attain these lower bounds.

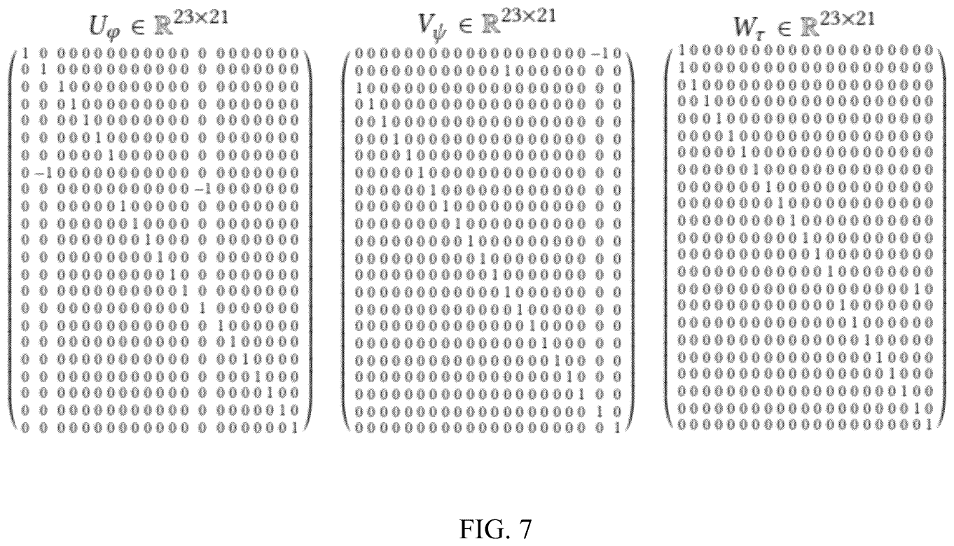

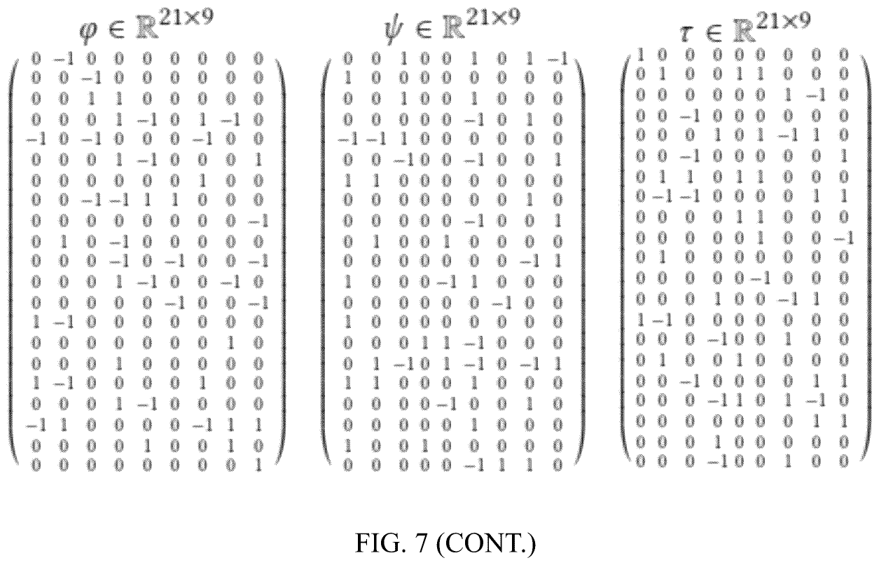

An optimal decomposition of the [symbol] 3,3,3; 23 [symbol] -algorithm can be seen in FIG. 7. Thanks to its leading coefficient of 2, the decomposed [symbol] 3,3,3; 23 [symbol] -algorithm can outperform the [symbol] 2,2,2; 7 [symbol] -algorithm on small matrices, despite its larger exponent. The optimal decomposition of the [symbol] 3,3,3; 23 [symbol] -algorithm is due to Ballard and Benson. All three encoding/decoding matrices contain duplicate rows, and thus optimally decompose. In contrast, the [symbol] 3,3,3; 23 [symbol] -algorithm due to Laderman contains no duplicate rows in any of the matrices, and therefore exhibits a leading coefficient of at-least 5 for any level of decomposition. Johnson and McLoughlin described a parametric family of [symbol] 3,3,3; 23 [symbol] -algorithms. Any choice of parameters results in duplicate rows in the encoding matrices, and moreover choosing x=y=z=1 yields duplicate rows in all three matrices, thus resulting in an optimally decomposing algorithm, similar to that of Ballard and Benson.

In addition to Smirnov's [symbol] 6,3,3; 40 [symbol] -algorithm, the present invention decomposed a [symbol] 6,3,3; 40 [symbol] -algorithm, of Tichavsky and Kováč. The original algorithm has a leading coefficient of 79.28 which was improved to 7 (a reduction by 91.1%), the same leading coefficient that was obtained for Smirnov's algorithm.

### ARITHMETIC AND COMMUNICATION MINIMIZING ALTERNATIVE BASIS FAST MATRIX MULTIPLICATION

As noted above, fast matrix multiplication algorithms can be of significant practical use, provided that their associated arithmetic and communication costs are low, not just asymptotically, but for small input sizes as well. To reduce costs of fast matrix multiplication algorithms, Karstadt and Schwartz introduced a method for computing fast matrix multiplication over alternative basis (the Alternative Basis Method), which reduces the arithmetic and communication costs by the same factor. See Elaye Karstadt and Oded Schwartz. Matrix multiplication, a little faster. In Proceedings of the 29th ACM Symposium on Parallelism in Algorithms and Architectures, pages 101-110, 2017; Elaye Karstadt and Oded Schwartz. Matrix multiplication, a little faster. Journal of the ACM (JACM), 67 (1):1-31,2020.

Beniamini and Schwartz introduced a method for computing fast matrix multiplication over alternative basis via sparse decomposition (the Sparse Decomposition Method), which further improves the arithmetic costs, albeit in exchange for increased communication costs. see Gal Beniamini and Oded Schwartz. Faster matrix multiplication via sparse decomposition. In The 31st ACM Symposium on Parallelism in Algorithms and Architectures, pages 11-22, 2019. Gal Beniamini and Oded Schwartz. Faster matrix multiplication via sparse decomposition. In The 31st ACM Symposium on Parallelism in Algorithms and Architectures, pages 11-22, 2019.

Disclosed herein is a technique, embodied as a computerized system, computer-implemented method, and computer program product, which provides for fast matrix multiplication calculations by reducing both the arithmetic costs as well as the communication costs within the memory hierarchy and between cores and processors of the computer system performing the calculation. In some embodiments, the present technique provides for improved arithmetic costs associated with the known methods of Alternative Basis and Sparse Decomposition, as well as other methods, without an associated increase in communication costs.

By way of background, in theoretical computer science, the computational complexity of matrix multiplication dictates how quickly the operation of matrix multiplication can be performed. The computational complexity is determined by the total number of arithmetic operations that the algorithm must perform to accomplish the multiplication, and by the communication costs associated with the computation, which are defined as the number of send and receive operations between components and processors of the computer system.

In terms of the total number of arithmetic operations, directly applying the mathematical definition of matrix multiplication requires n\hat{ }3 operations to multiply two n×n matrices. However, several algorithms have been developed that reduce the total number of arithmetic operations required by the mathematical multiplication method.

### Arithmetic Cost

Strassen's algorithm (see Volker Strassen. Gaussian elimination is not optimal. Numerische mathematik, 13(4):354-356, 1969) reduced the exponent of the arithmetic costs compared to classical matrix multiplication, from Θ(n³) to Θ(n^{log}^{₂}⁷). The leading coefficient of Strassen's algorithm's costs is 7 (as opposed to 2, of the classical algorithm). Further work by Winograd (see, Shmuel Winograd. Private communication with R. Probert [60], 1976.) reduced this coefficient to 6, by reusing results and decreasing the number of computations performed. Winograd's improvement also resulted in decreased communication cost coefficients. Further work reduced the leading coefficient of the arithmetic cost even further, to 5, by using a non-uniform divide-and-conquer pattern. Thus, this improvement came in exchange for an increase in the communication costs.

The Alternative Basis Method introduced a new technique for reducing the leading coefficient of the arithmetic cost of various algorithms, including Strassen-Winograd's algorithm for which a leading coefficient 5 was obtained. This is done by transforming the basis of the input and output matrices, at a cost of 0 (n² log n), to a basis in which the bilinear algorithm is sparser. The Alternative Basis Method reduces the leading coefficients of the communication costs as well.

The Sparse Decomposition Method generalized the Alternative Basis Method and obtained smaller leading coefficients for the arithmetic costs. However, the Sparse Decomposition Method introduces new low order terms into the arithmetic costs and higher order terms into the communication costs. For some algorithms, the Sparse Decomposition Method reduced the leading coefficient down to 2, which is the same as that of the classical algorithm, however, the communication costs are increased.

### Communication Costs

The runtime of many algorithms, matrix multiplication included, is often dictated by both the number of arithmetic operations (i.e., the arithmetic cost of running the algorithm, as defined hereinabove), as well as the amount of data movement within the memory hierarchy and between cores and processors within the computing system performing the algorithm.

The communication costs in a distributed memory architecture are defined to be the number of send and receive operations between processors. When multiplying two n×n matrices, using Θ(n^{ω}^{₀}) arithmetic operations, and P processors with local memory of size M words each, the communication costs lower bound is

$$Ω ( \frac{{n}^{{ω}_{0}}}{{M}^{\frac{{ω}_{0}}{2} - 1} P} + \frac{{n}^{2}}{{P}^{\frac{2}{{ω}_{0}}}} ) .$$

Although some parallel algorithms attain the lower bound up to a logarithmic factor in P, not all implementations do. The communication costs on a shared memory architecture are defined to be the number of read and write operations performed between the fast and main memory. In a sequential model, there is one processor with a fast memory of size M, and an unbounded slow memory. The communication cost in this model is defined as the number of reads and writes to the slow memory. The Alternative Basis Method can reduce the leading coefficient of the communication costs as well.

Accordingly, in some embodiments, the present technique provides for a new Combined Alternative Basis Method that improves the leading coefficient of the arithmetic costs of known Alternative Basis Methods for various algorithms (see Tables 2A-2B below).

In some embodiments, the present technique provides for a new Combined Alternative Basis Method that improves the leading coefficient of the arithmetic costs of the known Alternative Basis Method, beyond what the previous lower bound allows. For example, the present technique is configured to reduce the leading coefficient of the [symbol] 3,3,3; 23 [symbol] -algorithm from 5.36, which was believed to be optimal for this algorithm under the assumption of a singular decomposition, to 4.79.

TABLE 2A
Arithmetic costs of fast matrix multiplication algorithms with and without
alternative basis methods (linear operations)

| | | | | | Arithmetic Cost |
|---|---|---|---|---|---|
| Algorithm | Leading Monomial | Linear Operations | | | Improvement |
| | | | BCHKS¹, | Present | |
| | | Original | KS² | Technique | |
| [symbol] 2,2,2; 7 [symbol] | n^{log}^{₂}⁷ ≈ n^{2.80735} | 18 | 12 | 12 | — |
| [symbol] 3,2,2; 11 [symbol] | n^{log}^{₁₂}¹¹_{³} ≈ n^{2.89495} | 22 | 18 | 17 | 3.36% |
| [symbol] 2,3,2; 11 [symbol] | n^{log}^{₁₂}¹¹^{³} ≈ n^{2.89495} | 22 | 18 | 18 | — |
| [symbol] 4,2,2; 14 [symbol] | n^{log}^{₁₆}¹⁴^{³} ≈ n^{2.85551} | 48 | 28 | 25 | 5.70% |
| [symbol] 3,2,3; 15 [symbol] | n^{log}^{₁₈}¹⁵^{³} ≈ n^{2.81076} | 55 | 39 | 33 | 10.81% |
| [symbol] 3,2,3; 15 [symbol] | n^{log}^{₁₈}¹⁵^{³} ≈ n^{2.81076} | 64 | 39 | 33 | 10.81% |
| [symbol] 5,2,2; 18 [symbol] | n^{log}^{₂₀}¹⁸^{³} ≈ n^{2.89449} | 53 | 32 | 29 | 4.80% |
| [symbol] 2,3,4; 20 [symbol] | n^{log}^{₂₄}²⁰^{³} ≈ n^{2.82789} | 96 | 58 | 51 | 8.75% |
| [symbol] 3,3,3; 23 [symbol] | n^{log}^{₃}²³ ≈ n^{2.85404} | 97 | 61 | 53 | 10.67% |
| [symbol] 3,3,3; 23 [symbol] | n^{log}^{₃}²³ ≈ n^{2.85404} | 98 | 74 | 62 | 13.64% |
| [symbol] 3,3,3; 23 [symbol] | n^{log}^{₃}²³ ≈ n^{2.85404} | 84 | 68 | 60 | 9.76% |
| [symbol] 4,4,2; 26 [symbol] | n^{log}^{₃₂}²⁶^{³} ≈ n^{2.82026} | 235 | 105 | 87 | 14.79% |
| [symbol] 4,3,3; 29 [symbol] | n^{log}^{₃₆}²⁹^{³} ≈ n^{2.81898} | 164 | 102 | 88 | 13.55% |
| [symbol] 3,4,3; 29 [symbol] | n^{log}^{₃₆}²⁹^{³} ≈ n^{2.81898} | 167 | 105 | 87 | 14.43% |
| [symbol] 3,5,3; 36 [symbol] | n^{log}^{₄₅}³⁶^{³} ≈ n^{2.82414} | 199 | 139 | 115 | 15.87% |
| [symbol] 6,3,3; 40 [symbol] | n^{log}^{₅₄}⁴⁰^{³} ≈ n^{2.77429} | 1246 | 190 | 151 | 17.47% |
| [symbol] 3,3,6; 40 [symbol] | n^{log}^{₅₄}⁴⁰^{³} ≈ n^{2.7429} | 1822 | 190 | 152 | 17.25% |

TABLE 2B
Arithmetic costs of fast matrix multiplication algorithms with and without
alternative basis methods (leading coefficient)

| | | | | | Arithmetic Cost |
|---|---|---|---|---|---|
| Algorithm | Leading Monomial | Leading Coefficient | | | Improvement |
| | | | BCHKS¹, | Present | |
| | | Original | KS² | Technique | |
| [symbol] 2,2,2; 7 [symbol] | n^{log}^{₂}⁷ ≈ n^{2.80735} | 7.00 | 5.00 | 5.00 | — |
| [symbol] 3,2,2; 11 [symbol] | n^{log}^{₁₂}¹¹_{³} ≈ n^{2.89495} | 5.06 | 4.26 | 4.11 | 3.36% |
| [symbol] 2,3,2; 11 [symbol] | n^{log}^{₁₂}¹¹_{³} ≈ n^{2.89495} | 4.71 | 3.91 | 3.91 | — |
| [symbol] 4,2,2; 14 [symbol] | n^{log}^{₁₆}¹⁴^{³} ≈ n^{2.85551} | 8.33 | 5.27 | 4.97 | 5.70% |
| [symbol] 3,2,3; 15 [symbol] | n^{log}^{₁₈}¹⁵^{³} ≈ n^{2.81076} | 8.28 | 6.17 | 5.50 | 10.81% |
| [symbol] 3,2,3; 15 [symbol] | n^{log}^{₁₈}¹⁵^{³} ≈ n^{2.81076} | 9.61 | 6.17 | 5.50 | 10.81% |
| [symbol] 5,2,2; 18 [symbol] | n^{log}^{₂₀}¹⁸^{³} ≈ n^{2.89449} | 6.98 | 4.46 | 4.25 | 4.80% |
| [symbol] 2,3,4; 20 [symbol] | n^{log}^{₂₄}²⁰^{³} ≈ n^{2.82789} | 9.96 | 6.12 | 5.58 | 8.75% |
| [symbol] 3,3,3; 23 [symbol] | n^{log}^{₃}²³ ≈ n^{2.85404} | 7.93 | 5.36 | 4.79 | 10.67% |
| [symbol] 3,3,3; 23 [symbol] | n^{log}^{₃}²³ ≈ n^{2.85404} | 8.00 | 6.29 | 5.43 | 13.64% |
| [symbol] 3,3,3; 23 [symbol] | n^{log}^{₃}²³ ≈ n^{2.85404} | 7.00 | 5.86 | 5.29 | 9.76% |
| [symbol] 4,4,2; 26 [symbol] | n^{log}^{₃₂}²⁶^{³} ≈ n^{2.82026} | 18.10 | 7.81 | 6.66 | 14.79% |
| [symbol] 4,3,3; 29 [symbol] | n^{log}^{₃₆}²⁹^{³} ≈ n^{2.81898} | 10.27 | 6.73 | 5.81 | 13.55% |
| [symbol] 3,4,3; 29 [symbol] | n^{log}^{₃₆}²⁹^{³} ≈ n^{2.81898} | 10.27 | 6.73 | 5.75 | 14.43% |
| [symbol] 3,5,3; 36 [symbol] | n^{log}^{₄₅}³⁶^{³} ≈ n^{2.82414} | 9.62 | 6.87 | 5.78 | 15.87% |
| [symbol] 6,3,3; 40 [symbol] | n^{log}^{₅₄}⁴⁰^{³} ≈ n^{2.77429} | 55.63 | 8.9 | 7.34 | 17.47% |
| [symbol] 3,3,6; 40 [symbol] | n^{log}^{₅₄}⁴⁰^{³} ≈ n^{2.77429} | 79.28 | 8.9 | 7.41 | 17.25% |

¹Gal Beniamini, Nathan Cheng, Olga Holtz, Elaye Karstadt, and Oded Schwartz. Sparsifying the operators of fast matrix multiplication algorithms. arXiv preprint arXiv:2008.03759, 2020.
²Karstadt and Schwartz '20.

The notation used in column one of Tables 2A-2B denotes recursive matrix multiplication algorithms by their base case, as follows. Let n₀, m₀, k₀, t∈ [symbol] . Denote by an [symbol] n₀, m₀, k₀; t [symbol] -algorithm, a recursive matrix multiplication algorithm which multiplies matrices of dimensions n₀×m₀ and m₀×k₀ in its base case, using t multiplications. In each recursion level, each of the input matrices is divided into blocks of dimensions n₀×m₀, m₀×k₀, respectively. The base case of the algorithm is then applied recursively on the block matrices; linear combinations are computed element-wise, and multiplications are computed by recursive invocations of the algorithm.

In some embodiments, the present technique provides for a new alternative basis method that improves the leading coefficient of the arithmetic costs of previous Alternative Basis Methods for various algorithms (see Tables 2A-2B above), while attaining the same communication costs asymptotic lower bound, which asymptotically improves over the communication costs of the Sparse Decomposition Method.

In some embodiments, the present technique provides for a new Combined Alternative Basis Method that improves the leading coefficient of the arithmetic costs of previous Alternative Basis Methods for various algorithms, while attaining the same communication costs asymptotic lower bound, by reusing computations of the bilinear phase of an algorithm.

TABLE 3
Arithmetic cost and communication costs example: <3, 3, 3; 23>-algorithm

| Method | Arithmetic cost | Communication Costs |
|---|---|---|
| Original | 7.93 n^{log}^{₃}²³ − 6.93 n² | $Θ ( {n}^{{log}_{3} 23} \cdot {M}^{1 - \frac{{log}_{3} 23}{2}} )$ |
| Previous Alternative | $5.36 {n}^{{log}_{3} 23} + 3.11 {n}^{2} {log}_{3} n - 4.36 {n}^{2}$ | $Θ ( {n}^{{log}_{3} 23} \cdot {M}^{1 - \frac{{log}_{3} 23}{2}} )$ |
| basis | | |
| Mehtods | | |
| [Beniamini, | | |
| Cheng, Holz, | | |
| Karstadt, and | | |
| Schwartz '20, | | |
| Karstadt and | | |
| Schwartz '20] | | |
| Sparse Decomposition | $2 {n}^{{log}_{3} 23} + 6.75 {n}^{{log}_{3} 21} - 7.75 {n}^{2}$ | $Θ ( {n}^{{log}_{3} 23} \cdot {M}^{1 - {log}_{21} 23} )$ |
| Method | | |
| [Beniamini and | | |
| Schwartz '19] | | |
| Present technique, | $4.79 {n}^{{log}_{3} 23} + 3.11 {n}^{2} {log}_{3} n - 3.79 {n}^{2}$ | $Θ ( {n}^{{log}_{3} 23} \cdot {M}^{1 - \frac{{log}_{3} 23}{2}} )$ |
| applied to | | |
| alternative | | |
| basis | | |
| Present technique, | $4.21 {n}^{{log}_{3} 23} + 3.92 {n}^{{log}_{3} 11} - 7.13 {n}^{2}$ | $Θ ( {n}^{{log}_{3} 23} \cdot {M}^{1 - {log}_{3} 11} )$ |
| applied to | | |
| sparse | | |
| decomposition | | |

The leading coefficient of the arithmetic costs of the present technique is 4.79, which is lower than the previously known bound 5.36. Further, the communication cost asymptotic complexity is preserved.

In some embodiments, the present technique generalizes the lower bounds of previous Alternative Basis and Sparse Decomposition Methods on the leading coefficient of the arithmetic costs to any fast matrix multiplication algorithm, when using the Alternative Basis Method of Karstadt and Schwartz '20, the Sparse Decomposition Method of Beniamini and Schwartz '19, and the present technique. See Table 4 below for resulting lower bounds for various algorithms.

TABLE 4
Lower bounds on arithmetic costs leading coefficient

| | Leading coefficient lower bound | | | | | |
|---|---|---|---|---|---|---|
| | Lower bound on Alternative Basis | | | Lower bound on Sparse | | |
| | Methods | | | Decomposition Method | | |
| | Previously | Present | | Previously | Present | |
| Algorithm | known | Technique | Optimal | known | Technique | Optimal |
| [symbol] 2, 2, 2; 7 [symbol] | 5 | 5.00 | Yes | 5 | 5 | Yes |
| [symbol] 3, 2, 2; 11 [symbol] | 2 | 4.11 | Yes | 2 | 2 | |
| [symbol] 2, 3, 2; 11 [symbol] | 2 | 3.91 | Yes | 2 | 2 | |
| [symbol] 4, 2, 2; 14 [symbol] | 2 | 4.30 | | 2 | 4 | |
| [symbol] 3, 2, 3; 15 [symbol] | 2 | 5.00 | | 2 | 5 | |
| [symbol] 3, 2, 3; 15 [symbol] | 2 | 5.00 | | 2 | 5 | |
| [symbol] 5, 2, 2; 18 [symbol] | 2 | 4.125 | | 2 | 2 | Yes |
| [symbol] 2, 3, 4; 20 [symbol] | 2 | 4.93 | | 2 | 4 | |
| [symbol] 3, 3, 3; 23 [symbol] | 2 | 4.36 | | 2 | 2 | |
| [symbol] 3, 3, 3; 23 [symbol] | 2 | 5.00 | | 2 | 5 | |
| [symbol] 3, 3, 3; 23 [symbol] | 2 | 4.57 | | 2 | 3 | |
| [symbol] 4, 4, 2; 26 [symbol] | 2 | 5.00 | | 2 | 5 | |
| [symbol] 4, 3, 3; 29 [symbol] | 2 | 4.83 | | 2 | 3 | |
| [symbol] 3, 4, 3; 29 [symbol] | 2 | 4.83 | | 2 | 3 | |
| [symbol] 3, 5, 3; 36 [symbol] | 2 | 4.87 | | 2 | 3 | |
| [symbol] 6, 3, 3; 40 [symbol] | 2 | 5.00 | | 2 | 5 | |
| [symbol] 3, 3, 6; 40 [symbol] | 2 | 5.00 | | 2 | 5 | |
| [symbol] n, n, n; t [symbol] | 2 | 4.33 | | 2 | 2 | Yes |
| [symbol] n, n, n; t [symbol] | 2 | 5.00 | | 2 | 5 | |

### Dedicated Hardware Topology For Implementing Combined Alternative Basis

By way of background, matrix multiplication is often executed on specialized hardware using various interconnection network topologies. Traditional topologies such as 2D and 3D mesh or torus networks are commonly employed for this purpose. These topologies are well-suited for structured data movement, such as the classic matrix multiplication algorithm.

However, these hardware topologies typically introduce significant communication overhead when using fast matrix multiplication algorithms, defined as the amount of data movement within the memory hierarchy and between cores and processors within the computing system topology. Accordingly, any efforts to reduce the runtime and computational overhead of matrix multiplication algorithms may be hindered not only by the number of arithmetic operations (i.e., the arithmetic cost of running the algorithm, as defined hereinabove), but also by the overall communication cost.

Accordingly, in some embodiments, the present disclosure provides for a dedicated computer system for executing the present Combined Alternative Basis method for matrix multiplication of two or more input matrices. In some embodiments, the present computer system may be configured and/or adjusted to execute the present Combined Alternative Basis method for matrix multiplication of two or more input matrices of any size.

In some embodiments, the present computer system comprises a specified topology for connecting one or more hardware processing nodes, to perform efficient matrix multiplication-related operations within the context of the present Combined Alternative Basis algorithm, and fast matrix multiplication algorithms in general.

In some embodiments, the present computer system topology may be implemented in hardware, e.g., as a standalone chip, as a system-on-hip, as an IP core or block, as a field-programmable gate array (FGPA) code, or as any combination thereof.

In some embodiments, the present computer system topology comprises one or more processing units (PU), each configured to perform matrix multiplications on small blocks of a specified size n. In some embodiments, the small blocks may be sub-blocks of two or more input matrices intended for a matrix multiplication operation.

In some embodiments, each of the PUs in the present computer system topology is equipped with one or more matrix multiplication engines (MME) capable of executing matrix multiplication operations. These MMEs are optimized for performing operations on small blocks, which are then combined according to the fast matrix multiplication algorithm. The MMEs may use the classic algorithm, or combine it with a fast matrix multiplication algorithm. The MMEs use a pipeline architecture to overlap different stages of computation, such as multiplication, accumulation, and data fetching, ensuring continuous operation, minimizing idle cycles.

In some embodiments, the PUs are interconnected via a communication network which provides for high-bandwidth, low-latency communication, such as, but not limited to, a fat-free communication network or a butterfly communication network. In some embodiments, the present communication network is capable of dynamically adjusting routes to avoid bottlenecks, further improving communication efficiency.

In some embodiments, the present computer system topology employs a memory hierarchy comprising a combination of local memory for or associated with each individual PUs, and shared memory accessible to all PUs. In some embodiments, the local memory may be used by each respective PU to store frequently accessed data to reduce latency, while the shared memory may be used for storing intermediate results and facilitating communication between the plurality of PUs. The memory system is designed to maximize data reuse, minimizing the need for external memory accesses.

In some embodiments, the present computer system topology may further comprise a scheduler which operates according to the workflow schedule of the fast matrix multiplication algorithm, e.g., in an ordering corresponding to BFS (Breadth First Search) and DFS (Depth First Search) methods.

In some embodiments, each PU may comprise a basis transformation unit (BTU), configured to perform transformations of input matrices (or blocks thereof) into an alternative basis. in some embodiments, the BTUs may be implemented in hardware only, in software only, or in a combination of both hardware and software. In some embodiments, each BTU is optimized for specific transformations into alternative bases. In some embodiments, the BTUs may be designed to handle the recursive nature of the transformations, operating in a pipeline to process large matrices efficiently. In some embodiments, each BTU may be integrated into a respective one of the PUs, such that the results of the basis transformation are fed directly into the PU for performing the multiplication calculations, to minimize data movement and latency within the present computer system topology. In some embodiments, the present BTUs may be further configured to perform non-homomorphic transformations, wherein the result of the transformation calculation output is larger than the input.

In some embodiments, the present computer system topology may comprise a main controller configured for overseeing and coordinating the various hardware subsystems and processes of the network.

In some embodiments, the present computer system topology may comprise a memory controller unit configured to manage the flow of data going to and from the shared memory of the present computer system.

In some embodiments, the present computer system topology is configured to balance computation and communication costs to optimize the running time of the present Combined Alternative Basis algorithm.

In some embodiments, the present computer system topology is configured such that the time period required to load input sub-blocks to a PU is approximately equal to the time period required to perform a multiplication operations of the sub-blocks, as represented by the equation

$$γ {n}^{{ω}_{0}} \approx α + β {n}^{2} ,$$

where
ω₀ denotes the exponent of the matrix multiplication algorithm,
γ denotes the time required for a single arithmetic operation,
α represents the communication latency,
βis the communication bandwidth, and
n is the dimension of the matrix, which is related to the memory size M by

n=Θ(\sqrt{M}).

From this, there can be derived

$$γ {M}^{\frac{{ω}_{0}}{2}} \approx c ( α + β M ) .$$

The constant c is determined by several factors, including the number of block reads and writes per single block multiplication.

Accordingly, in some embodiments, the computer system topology which may be adjusted to balance the computational resources and communication infrastructure of the computer system topology may include, but are not limited to:
Processor silicone area,
PU processing speed,
local memory size,
shared memory size,
communication network bandwidth, and
communication network latency
   Adjusting these parameters may be configured to optimize the running time for executing the present Combined Alternative Basis algorithm to perform fast matrix multiplications over matrix blocks of size n, according to the following equation:

$$γ {M}^{\frac{{ω}_{0}}{2}} \approx c ( α + β M ) .$$

### PRELIMINARIES

### Notations

Notation 2.1. a, b∈ [symbol] . Denote[a, b):={a, . . . , b−1}, [a]:=[1, . . . , a+1), and a, b:=[a+1, b).

Notation 2.2. Let R be a ring, and let A∈R^{n×m}. Denote by nnz(A):=|{x∈A|x≠0}| the number of non-zero entries in A, by nns (A):=|{x∈A|x∉{0, ±1}}| the number of non-singleton entries in A.

Notation 2.3. Let R be a ring, and let A∈R^{n×m}. Denote by q_{A} the additive cost of applying A to some input of dimensions m×1. That is, q_{A}=nns(A)+nnz(A)−n.

Notation 2.4. Let R be a ring, and let A∈R^{n×m} where n=n₀^{l}, m=m₀^{l}for some l∈ [symbol] . Then the row order vectorization of A is recursively defined as

$$\overleftarrow{A} = {( \overleftarrow{{A}_{1 , 1}} , … , \overleftarrow{{A}_{1 , {m}_{0}}} , \overleftarrow{{A}_{{n}_{0} , 1}} , … , \overleftarrow{{A}_{{n}_{0} , {m}_{0}}} )}^{T}$$

where A_{i,j} is the (i, j)'th block of A, of size

$$\frac{n}{{n}_{0}} \times \frac{m}{{m}_{0}} .$$

### Recursive Matrix Multiplication

Recursive matrix multiplication algorithms are denoted by their base case, as follows.

Notation 2.5. Let n₀, m₀, k₀, t∈ [symbol] . Denote by an [symbol] n₀, m₀, k₀; t [symbol] -algorithm, a recursive matrix multiplication algorithm which multiplies matrices of dimensions n₀×m₀ and m₀×k₀ in its base case, using t multiplications.

In each recursion level, each of the input matrices is divided into n₀×m₀, m₀×k₀ block, respectively. The base case of the algorithm is then applied recursively on the block matrices; linear combinations are computed element-wise, and multiplications are computed by recursive invocations of the algorithm. See Algorithm 3 below for an algorithmic description.

Fact 2.6. Bilinear Representation, Encoding/Decoding Matrices. Let R be a ring, let n₀, m₀, k₀, t∈ [symbol] and let f:Rⁿ^{₀}^{·m}^{₀}×R^{m}^{₀}^{·k}^{₀}→Rⁿ^{₀}^{·k}^{₀} be a bilinear algorithm that performs t multiplications. Then there exist U∈R^{t×n}^{₀}^{·m}^{₀}, V∈R^{t×m}^{₀}^{·k}^{₀}, and W∈R^{t×n}^{₀}^{·k}^{₀} such that ∀x∈Rⁿ^{₀}^{·m}^{₀}, ∀y∈R^{m}^{₀}^{·k}^{₀}: f(x, y)=W^{T}(U·x)⊙(V·y), where ⊙ is the element-wise product.

The encoding/decoding matrices of a bilinear algorithm are denoted [symbol] U, V, W [symbol] , where U and V are the encoding matrices and W is the decoding matrix.

The algorithm that computes f (·,·) is denoted by [symbol] , which is represented by [symbol] U, V, W [symbol] .

| Algorithm 3: Recursive bilinear algorithm | |
|---|---|
| Input: x ∈ R⁽ⁿ^{₀} ^{m}^{₀}⁾^{^{l}}, y ∈ R^{(m}^{₀}^{·k}^{₀}⁾^{^{l}} | |
| Output: f(x, y) | |
| | 1. function [symbol] (x, y, l): |
| | 2. Compute \tilde{x} = U · x [symbol] Encode x |
| | 3. Compute \tilde{y} = V · y [symbol] Encode y |
| | 4. if l = 1 then |
| | 5. ž = \tilde{x}⊙\tilde{y} [symbol] Base case |
| | 6. else |
| | 7. for i = 1 to t do |
| | 8. \tilde{z}ᵢ = [symbol] (\tilde{x}ᵢ, \tilde{y}ᵢ, l − 1) [symbol] Recursive call |
| | 9. Compute z = W^{T} · \tilde{z} [symbol] Decode z |
| | 10. return z |

Claim 2.8. Let R be a ring, let n₀, m₀, k₀, t∈ [symbol] , and let ALG_{U,V,W} be an n₀, m₀, k₀; t-algorithm. Then ALG_{U,V,W} performs q=q_{U}+q_{V}+q_{W}^{T} linear operations at its base case (see Notation 2.3 hereinabove).

Claim 2.9. Let R be a ring, let n₀, m₀, k₀, t∈ [symbol] , and let ALG_{U,V,W} be an n₀, m₀, k₀; t-algorithm. The arithmetic cost of ALG_{U,V,W} when receiving as inputs matrices of dimensions n×m and m×k where n=n₀^{l}, m=m₀^{l}, k=k₀^{l} for some l∈ [symbol] , is

$${F}_{ALG} n , m , k = \frac{{q}_{U}}{t - {n}_{0} {m}_{0}} + \frac{{q}_{V}}{t - {m}_{0} {k}_{0}} + \frac{{q}_{{W}^{T}}}{t - {n}_{0} {k}_{0}} + 1 {n}^{{log}_{{n}_{0}} t} - \frac{{q}_{U} \cdot nm}{t - {n}_{0} {m}_{0}} - \frac{{q}_{V} \cdot mk}{t - {m}_{0} {k}_{0}} - \frac{{q}_{{W}^{T}} \cdot nk}{t - {n}_{0} {k}_{0}} .$$

claim 2.10. Let R be a ring, let n₀, m₀, k₀, t∈N, and let ALG =ALG_{U,V,W} be an n₀, m₀, k₀; t-algorithm. Assume ALG is computed with no additional memory requirements. The communication cost of ALG, when receiving as inputs matrices of dimensions n×m and m×k where n=n₀^{l}, m=m₀^{l}, k=k₀^{l} for some l∈ [symbol] is

$${IO}_{ALG} ( n , m , k , M ) \leq ( ( \frac{3 {q}_{U}}{t - {n}_{0} {m}_{0}} + 1 ) \cdot {( {n}_{0} {m}_{0} )}^{j} + ( \frac{3 {q}_{V}}{t - {m}_{0} {k}_{0}} + 1 ) \cdot {( {m}_{0} {k}_{0} )}^{j} + ( \frac{3 {q}_{{W}^{T}}}{t - {n}_{0} {k}_{0}} + 1 ) \cdot {( {n}_{0} {k}_{0} )}^{j} ) {t}^{l - j} - \frac{3 {q}_{U}}{t - {n}_{0} {m}_{0}} \cdot nm - \frac{3 {q}_{V}}{t - {m}_{0} {k}_{0}} \cdot mk - \frac{3 {q}_{{W}^{T}}}{t - {n}_{0} {k}_{0}} \cdot nk$$

where j∈[l] is the maximal to satisfy (n₀m₀)^{j}+(m₀k₀)^{j}+(n₀k₀)^{j}≤M where j∈[l] is the maximal to satisfy (n₀m₀)^{j}+(m₀k₀)^{j}+(n₀k₀)^{j}≤M.

Corollary 2.11. Let R be a ring, let n₀, t∈ [symbol] , and let ALG=ALG_{U}_{_{ϕ}}_{,V}_{_{ψ}}_{,W}_{_{τ}} be an [symbol] n₀, n₀, n₀; t [symbol] _{ϕ, ψ, τ}-algorithm. The communication cost of ALG, when receiving as inputs matrices of dimensions n×n where n=n₀^{l} for some l∈ [symbol] , is

$${IO}_{ALG} ( n , M ) = Θ ( {n}^{{log}_{{n}_{0}} t} \cdot {M}^{1 - \frac{{log}_{{n}_{0}} t}{2}} ) .$$

### Sparse Decomposition Matrix Multiplication

The leading coefficient of the arithmetic costs of fast matrix multiplication depends on q_{U}, q_{V}, q_{W}^{T} (see claim 2.9 above), and can be reduced, by finding an alternative basis in which [symbol] U, V, W [symbol] are sparser.

The alternative basis method can then be generalized into a method that reduces arithmetic cost even further, by using linear maps into intermediate dimensions, rather than invertible linear maps. The present technique uses the notations of the sparse decomposition method for generality, however all holds for the alternative basis method as well.

Definition 2.12. Let R be a ring, let n₀, m₀, k₀, t∈ [symbol] , and let ALG=ALG_{U,V,W} be an (n₀, m₀, k₀; t)-algorithm. Let s_{U}∈[n₀m₀, t), s_{V}∈[m₀k₀, t), s_{W}∈[n₀k₀, t), and let U_{ϕ}∈R^{t×s}^{_{U}}, V_{ψ}∈R^{t×s}^{_{V}}, W_{τ}∈R^{t×s}_{W}, ϕ: R^{s}^{_{U}}^{×(n}^{₀}^{·m}^{₀}⁾, ψ: R^{s}^{_{V}}^{×(m}^{₀}^{·k}^{₀}⁾, τ: R^{s}^{_{W}}^{×(n}^{₀}^{·k}^{₀}⁾, be decompositions of the matrices U, V, W, that satisfy U=U_{ϕ}·ϕ, V=V_{ψ}·ψ, W=W_{τ}·τ. Then U_{ϕ}, V_{ψ}, W_{τ}, ϕ, ψ, τ represent a sparse decomposition of ALG with levels t−S_{U}, t−S_{V}, t−S_{W}.

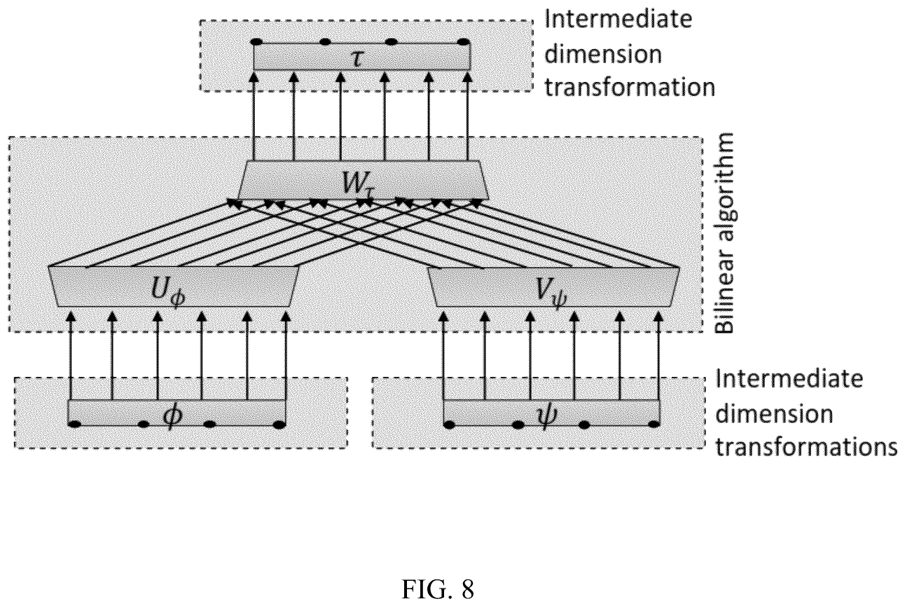

Given an [symbol] n₀, m₀, k₀; t [symbol] -algorithm represented by encoding/decoding matrices [symbol] U, V, W [symbol] , a sparse decomposition algorithm ALG_{SDMM} is defined as in Algorithm 4 below. FIG. 8 represents the computation diagram of sparse decomposition matrix multiplication, wherein each shaded rectangular represents a recursion tree.

| Algorithm 4: Sparse decomposition matrix | |
|---|---|
| multiplication | |
| Input: A ∈ R^{n×m}, B ∈ R^{m×k}, where n = n₀^{l}, m = m₀^{l}, l ∈ [symbol] | |
| Output: C = A · B | |
| | 1. function ALG_{SDMM}(A, B): |
| | 2. Ã = ϕ( [symbol] ) [symbol] Transform A |
| | 3. \tilde{B} = ( [symbol] ) [symbol] Transform B |
| | 4. \tilde{C} = [symbol] (A, B) [symbol] Apply Algorithm 3 |
| | 5. [symbol] = τ^{T} (\tilde{C}) [symbol] Transform the result |
| | 6. return C |

Claim 2.13. Let R be a ring and let ψ: Rⁿ^{₀}^{·m}^{₀}→Rⁿ^{₀}^{·m}^{₀} be an automorphism. The arithmetic complexity of applying ψ to an input of dimensions n×m where n=n₀^{l}, m=m₀^{l}, for some l∈ [symbol] , is

$${F}_{ψ} ( n , m ) = \frac{{q}_{ψ} \cdot nml}{{n}_{0} {m}_{0}} .$$

Corollary 2.14. Let R be a ring, and let n₀, m₀, k₀, t∈ [symbol] . Let ALG_{SDMM} be a sparse decomposition algorithm, with matrices U_{ϕ}, V_{ψ}, W_{τ}, and automorphisms ϕ, ψ, τ. The arithmetic cost of ALG_{SDMM}, when receiving as inputs matrices of dimensions n×m and m×k where n=n₀^{l}, m=m₀^{l}, k=k₀^{l} for some l∈ [symbol] , is

$${F}_{{ALG}_{SDMM}} ( n , m , k ) = ( \frac{{q}_{{U}_{ϕ}}}{t - {n}_{0} {m}_{0}} + \frac{{q}_{{V}_{ψ}}}{t - {m}_{0} {k}_{0}} + \frac{{q}_{{W}_{τ}^{T}}}{t - {n}_{0} {k}_{0}} + 1 ) \cdot {t}^{l} - \frac{{q}_{{U}_{ϕ}} \cdot nm}{t - {n}_{0} {m}_{0}} - \frac{{q}_{{V}_{ψ}} \cdot mk}{t - {m}_{0} {k}_{0}} - \frac{{q}_{{W}_{τ}^{T}} \cdot nk}{t - {n}_{0} {k}_{0}} + \frac{{q}_{ϕ} \cdot nml}{{n}_{0} {m}_{0}} + \frac{{q}_{ψ} \cdot mkl}{{n}_{0} {m}_{0}} + \frac{{q}_{{τ}^{T}} \cdot nkl}{{n}_{0} {k}_{0}} .$$

Corollary 2.15. Let R be a ring, let n₀, m₀, k₀, t∈ [symbol] and let s_{U}∈(n₀m₀, t), s_{V}∈(m₀k₀, t), s_{W}∈(n₀k₀, t). Let ALG_{SDMM} be a sparse decomposition algorithm, with matrices U_{ϕ}, V_{ψ}, W_{τ}, ϕ, ψ, τ and levels t−S_{U}, t−S_{V}, t−S_{W}. The arithmetic cost of ALG_{SDMM}, when receiving as inputs matrices of dimensions n×m and m×k where n=n₀^{l}, m=m₀^{l}, k=k₀^{l} for some l∈ [symbol] , is

$${F}_{{ALG}_{SDMM}} ( n , m , k ) = ( \frac{{q}_{{U}_{ϕ}}}{t - {s}_{U}} + \frac{{q}_{{V}_{ψ}}}{t - {s}_{V}} + \frac{{q}_{{W}_{τ}}}{t - {s}_{W}} + 1 ) {t}^{l} + ( \frac{{q}_{ϕ}}{{s}_{U} - {n}_{0} {m}_{0}} - \frac{{q}_{{U}_{ϕ}}}{t - {s}_{U}} ) \cdot {s}_{U}^{l} + ( \frac{{q}_{ψ}}{{s}_{V} - {m}_{0} {k}_{0}} - \frac{{q}_{{V}_{ψ}}}{t - {s}_{V}} ) \cdot {s}_{V}^{l} + ( \frac{{q}_{{τ}^{T}}}{{s}_{0} - {n}_{0} {k}_{0}} - \frac{{q}_{{W}_{τ}}}{t - {s}_{W}} ) \cdot {s}_{W}^{l} - \frac{{q}_{ϕ} \cdot nm}{{s}_{U} - {n}_{0} {m}_{0}} - \frac{{q}_{ψ} \cdot mk}{{s}_{V} - {m}_{0} {k}_{0}} - \frac{{q}_{{τ}^{T}} \cdot nk}{{s}_{0} - {n}_{0} {k}_{0}} .$$

claim 2.16. Let R be a ring, let n₀, t∈ [symbol] and let s₀∈[n₀², t). Let ALG_{SDMM} be a sparse decomposition algorithm, with matrices U_{ϕ}, V_{ψ}, W_{τ}, ϕ, ψ, τ and levels t−S₀. The communication costs of ALG_{SDMM}, when receiving as inputs matrices of dimensions n×n where n=n₀^{l} for some l∈ [symbol] , is

$${IO}_{{ALG}_{SDMM}} ( n , M ) = Θ ( {n}^{{log}_{{n}_{0}} t} \cdot {M}^{1 - {log}_{{s}_{0}} t} ) .$$

Following is the communication costs analysis of the rectangular case of any bilinear algorithm, from which there can be inferred the communication costs of the sparse decomposition method.

Proof of claim 2.10. The i'th step of the recursion consists of tⁱ subproblems of dimensions

$$\frac{n}{{n}_{0}^{i}} , \frac{m}{{m}_{0}^{i}} , \frac{k}{{k}_{0}^{i}} .$$

In each call, q_{U}_{_{ϕ}} linear operations are performed on the input blocks of size

$$\frac{nm}{{n}_{0}^{i} {m}_{0}^{i}} ,$$

q_{V}_{_{ψ}} linear operations are performed on the input blocks of size

$$\frac{mk}{{m}_{0}^{i} {k}_{0}^{i}} ,$$

and q_{W}_{_{τ}}_{^{T}} linear operations are performed on the resulting submatrices consisting of

$$\frac{nk}{{n}_{0}^{i} {k}_{0}^{i}}$$

elements each. Each linear operation requires at most reading two inputs, and writing an output.

The base case is when the problem fits entirely into the fast memory (when all input and output matrices fit into the fast memory). Then, the two input matrices require read operations, and the output matrix requires write operations.

Therefore, if

$$\frac{nm + mk + nk}{M} > 1$$

then

$${IO}_{ALG} ( n , m , k , M ) = t \cdot IO ( \frac{n}{{n}_{0}} , \frac{m}{{m}_{0}} , \frac{k}{{k}_{0}} , M ) + 3 ( {q}_{U} \cdot \frac{nm}{{n}_{0} {m}_{0}} + {q}_{V} \cdot \frac{mk}{{m}_{0} {k}_{0}} + {q}_{{W}^{T}} \cdot \frac{nk}{{n}_{0} {k}_{0}} )$$

otherwise,

$${IO}_{ALG} ( n , m , k , M ) \leq nm + mk + nk \\ {IO}_{ALG} ( n , m , k ) \geq \frac{nm}{{n}_{0} {m}_{0}} + \frac{mk}{{m}_{0} {k}_{0}} + \frac{nk}{{n}_{0} {k}_{0}}$$

Let j∈[l] be the maximal to satisfy (n₀m₀)^{j}+(m₀k₀)^{j}+(n₀k₀)^{j}≤M. Thus

$$I {0}_{A L G} ( n , m , k , M ) =$$

$${\sum }_{i = 0}^{( l - j ) - 1} 3 ( {q}_{U} \cdot \frac{n m}{{( {n}_{0} {m}_{0} )}^{i + 1}} ) \cdot {t}^{i}$$

$$+ {\sum }_{i = 0}^{( l - j ) - 1} 3 ( {q}_{V} \cdot \frac{m k}{{( {m}_{0} {k}_{0} )}^{i + 1}} ) \cdot {t}^{i}$$

$$+ {\sum }_{i = 0}^{( l - j ) - 1} 3 ( {q}_{{W}^{T}} \cdot \frac{n k}{{( {n}_{0} {k}_{0} )}^{i + 1}} ) \cdot {t}^{i}$$

$$+ ( \frac{n m}{{( {n}_{0} {m}_{0} )}^{l - j}} + \frac{m k}{{( {m}_{0} {k}_{0} )}^{l - j}} + \frac{n k}{{( {n}_{0} {k}_{0} )}^{l - j}} ) \cdot {t}^{( l - j )}$$

Corollary A1. Let R be a ring, let n₀, m₀, k₀, t∈ [symbol] and let s_{U}∈{n₀m₀, . . . , t−1}, S_{V}∈{m₀k₀, . . . , t−1}, s_{W}∈{n₀k₀, . . . , t−1}. Let ALG_{SDMM} be a sparse decomposition algorithm, with linear maps ϕ: R^{s}^{_{U}}^{×[n}^{₀}^{m}^{₀}^{,t)}, ψ: R^{s}^{_{V}}^{×[m}^{₀}^{k}^{₀}^{,t)}, τ: R^{s}^{_{W}}^{×[n}^{₀}^{k}^{₀}^{,t)}, and a bilinear phase represented by U_{ϕ}531 R^{t×s}^{_{U}}, V_{ψ}∈R^{t×s}^{_{V}}, W_{τ}∈R^{t×s}^{_{W}}. The communication costs of the bilinear phase of ALG_{SDMM}, when receiving as inputs matrices of dimensions n×m and m×k where n=n₀^{l}, m=m₀^{l}, k=k₀^{l} for some l∈ [symbol] , is

$$I {0}_{A L {G}_{S D M M}} ( {s}_{U} , {s}_{V} , {s}_{U} , M ) = ( ( \frac{3 {q}_{{U}_{ϕ}}}{t - {s}_{U}} + 1 ) \cdot {s}_{U}^{j}$$

$$+ ( \frac{3 {q}_{{V}_{ψ}}}{t - {s}_{V}} + 1 ) \cdot {s}_{V}^{j} + ( \frac{3 {q}_{{W}_{τ}^{T}}}{t - {s}_{W}} + 1 ) \cdot {s}_{W}^{j} ) {t}^{l - j} +$$

$$- \frac{3 {q}_{{U}_{ϕ}}}{t - {s}_{U}} \cdot {s}_{U} - \frac{3 {q}_{{V}_{ψ}}}{t - {s}_{V}} \cdot {s}_{V} - \frac{3 {q}_{{W}_{τ}^{T}}}{t - {s}_{W}} \cdot {s}_{W}$$

where s_{U}=s_{U}^{l}, S_{V}=s_{V}^{l}, S_{W}=s_{W}^{l}, and j∈[l] is the maximal to satisfy s_{U}^{j}+s_{V}^{j}+s_{U}^{j}≤M.

Proof of claim 2.16 by corollary A1.

$$I {0}_{A L {G}_{S D M M}} ( n , M ) =$$

$$( \frac{{q}_{{U}_{ϕ}} + {q}_{{V}_{ψ}} + {q}_{{W}_{τ}^{T}}}{t - {s}_{0}} + 1 ) \cdot {s}_{0}^{j} \cdot {t}^{l - j}$$

$$- 3 \cdot \frac{{q}_{{U}_{ϕ}} + {q}_{{V}_{ψ}} + {q}_{{W}_{τ}^{T}}}{t - {s}_{0}} \cdot {s}_{0}^{{log}_{{n}_{0}} n}$$

where s=s₀^{l} and j∈[l] is the maximal to satisfy 3s₀^{j}≤M therefore j =logₛ_{₀}

$$\frac{M}{3} .$$

$$I O ( s , M ) = 3 \cdot ( \frac{{q}_{{U}_{ϕ}} + {q}_{{V}_{ψ}} + {q}_{{W}_{τ}^{T}}}{t - {s}_{0}} + 1 ) \cdot {s}_{0}^{{log}_{{s}_{0}} \frac{M}{3}} \cdot {t}^{l - {log}_{{s}_{0}} \frac{M}{3}}$$

$$- 3 \cdot \frac{{q}_{{U}_{ϕ}} + {q}_{{V}_{ψ}} + {q}_{{W}_{τ}^{T}}}{t - {s}_{0}} \cdot {s}_{0}^{{log}_{{n}_{0}} n}$$

### Combined Alternative Basis

In the bilinear phase of an algorithm, linear combinations are often computed more than once, causing an increase in both arithmetic and communication costs. One can avoid these repeated computations by reusing intermediate results. Formally, this can be represented by decomposing each encoding/decoding matrix into a series of matrices. These matrices are applied one after the other in the same recursion level.

Example 3. Assume that U contains

$$A = ( \begin{matrix}1 & 1 & 1 \\ 0 & 1 & 1 \\ 0 & 0 & 1\end{matrix} )$$

as a sub-matrix. Applying A to an input takes nnzA+nnsA-−3=3 operations. In contrast,

$$A = ( \begin{matrix}1 & 1 & 0 \\ 0 & 1 & 0 \\ 0 & 0 & 1\end{matrix} ) ( \begin{matrix}1 & 0 & 0 \\ 0 & 1 & 1 \\ 0 & 0 & 1\end{matrix} ) .$$

Applying these matrices consecutively to an input takes only two operations.

Definition 3.1 Given a sparse decomposition algorithm U_{ϕ}, V_{ψ}, W_{τ}, ϕ, ψ, τ of ALG_{U,V,W} with levels t−S_{U}, t−S_{V}, t−S_{W} and a decomposition

$${U}_{ϕ} = {U}_{ϕ}^{( 1 )} \cdot {U}_{ϕ}^{( 2 )} \cdot … \cdot {U}_{ϕ}^{( {r}_{U} )}$$

$${V}_{ψ} = {V}_{ψ}^{( 1 )} \cdot {V}_{ψ}^{( 2 )} \cdot … \cdot {V}_{ψ}^{( {r}_{V} )}$$

$${W}_{τ} = {W}_{τ}^{( 1 )} \cdot {W}_{τ}^{( 2 )} \cdot … \cdot {W}_{τ}^{( {r}_{W} )}$$

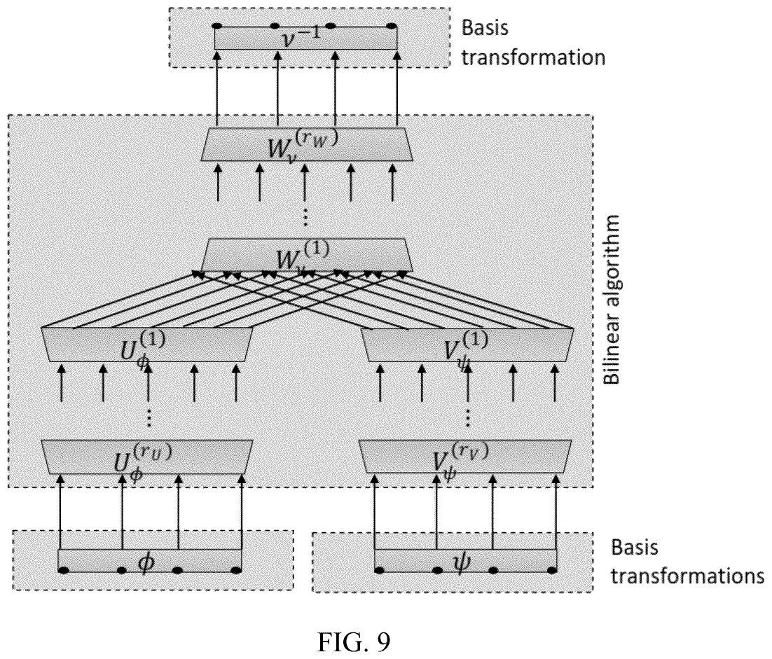

A Combined Alternative Basis algorithm ALG_{CABMM} may be defined as in Algorithm 7 hereinbelow, which is then used in Algorithm 8 below. FIG. 9 shows the Combined Alternative Basis computation diagram. FIG. 9 represents the corresponding computation graph.

Since U_{ϕ}=U_{ϕ}⁽¹⁾· . . . . ·U_{ϕ}^{(r}^{_{U}}⁾, applying U_{ϕ}^{(r}^{_{U}}⁾, . . . , U_{ϕ}⁽¹⁾ to an input is equivalent to applying U_{ϕ} to the input. This similarly holds for the decompositions of V_{ψ} and W_{τ}.

The algorithm consists of four recursion trees (one for each of steps 2-5 in Algorithm 4 hereinabove). Three of the recursion trees are used to benefit from the sparse decomposition method, and one (step 4 in Algorithm 4) is the bilinear phase that contributes most of the arithmetic and communication costs. The only difference from Algorithm 4) is the bilinear phase, which is described in detail in Algorithm 7 hereinbelow.

| Algorithm 5: Encoding a matrix for Combined | |
|---|---|
| Alternative Basis | |
| Input: x ∈ [symbol] | |
| Output: Q · x | |
| | 1. function [symbol] |
| | 2. \tilde{x}^{(r}^{_{Q}}⁺¹⁾: = x |
| | 3. for i = r_{Q}, ... , 1 do |
| | 4. \tilde{x}⁽ⁱ⁾ = Q⁽ⁱ⁾ · \tilde{x}⁽ⁱ⁺¹⁾ |
| | 5. return \tilde{x}⁽¹⁾ |

A decoding Algorithm 6 hereinbelow is defined similarly to the encoding Algorithm 5:

| Algorithm 6: Decoding for Combined | |
|---|---|
| Alternative Basis | |
| Input: x ∈ [symbol] | |
| Output: Q^{T} · x | |
| | 1. function [symbol] |
| | 2. \tilde{x}^{(r}^{_{Q}}⁺¹⁾: = x |
| | 3. for i = 1, ... , r_{Q} do |
| | 4. \tilde{x}⁽ⁱ⁾ = Q(i) · \tilde{x}⁽ⁱ⁺¹⁾ |
| | 5. return \tilde{x}⁽¹⁾ |

| Algorithm 7: Recursive bilinear phase of | |
|---|---|
| Combined Alternative Basis | |
| Input: x ∈ [symbol] , y ∈ [symbol] | |
| Output: f(x, y) | |
| | 1. function ALG_{f}(x, y, l): |
| | 2. \tilde{x} = [symbol] |
| | 3. \tilde{y} = [symbol] |
| | 4. if l = 1 then |
| | 5. \tilde{z} = \tilde{x} ⊙ \tilde{y} |
| | 6. else |
| | 7. for i = 1 to t do |
| | 8. \tilde{z} = ALG_{f}(\tilde{x}ᵢ, \tilde{y}ᵢ, l − 1) |
| | 9. z = [symbol] |
| | 10. return z |

| Algorithm 8: Sparse decomposition | |
|---|---|
| matrix multiplication | |
| Input: A ∈ R^{n×m}, B ∈ R^{m×k}, where n = n₀^{l}, m = m₀^{l}, l ∈ [symbol] | |
| Output: C = A · B | |
| Function ALG_{SDMM}(A, B): | |
| | 1. Compute Ã = ϕ( [symbol] ) [symbol] Transform A |
| | 2. Compute \tilde{B} = ψ( [symbol] ) [symbol] Transform B |
| | 3. Compute \tilde{C} = [symbol] (Ã, \tilde{B}) [symbol] Algorithm 7 |
| | 4. Compute [symbol] = τ^{T}(\tilde{C}) [symbol] Transform the result |
| | 5. return C |

Despite the general description of the present Combined Alternative Basis method, it may be needed to search for the decomposition manually, e.g., using one heuristic, When U contains a combinatorial rectangle, which can be split to its outer product to save operations (similar to the decomposition in Example 3).

### Costs Analysis of The Present Technique

The costs of the present Combined Alternative Basis method are hereinbelow analyzed.

### Arithmetic and Communication Costs

The algorithm consists of four recursion trees (one for each of steps 2-5 in Algorithm 4). The same analysis as previously detailed holds for the three recursion trees used for the sparse decomposition method. As for the bilinear phase, the number of linear operations required to compute the linear combinations (the encoding and decoding phases) under the present technique differs from previous Alternative Basis Methods (such as Karstadt and Schwartz '20).

In some embodiments, the number of recursions is determined as follows: Consider a decomposition U=U₁· . . . ·Uₖ, and recursion trees R₁, . . . , Rₘ of depth l each, where each Rᵢ contains a sequence of one or more Uⱼs. The cost of the decomposing recursion is composed of two parts: communication and computation. Denote the cost of the base case of the ith recursion Rᵢ by qᵢ, the input dimension by nᵢ₋₁, and the output dimension by nᵢ. Note that nₘ₊₁=t where t is the number of multiplications in the original algorithm. The arithmetic cost of the entire recursion tree Rᵢ is

$$\frac{q}{{n}_{i + 1} - {n}_{i}} ( {n}_{i + 1}^{l} - {n}_{i}^{l} )$$

and the communication cost is bounded by

$$O ( \frac{{n}^{l}}{{M}^{{log}_{{n}_{i}} {n}_{i + 1}}} M ) .$$

The split of Uⱼs to different recursion trees optimizes according to these two costs and may use additional matrices (such as energy costs and silicon area).

Theorem 4. Let R be a ring, let n₀, m₀, k₀, t∈ [symbol] . Let ALG be an [symbol] n₀, m₀, k₀; t [symbol] -algorithm and let ALG_{SDMM} be a sparse decomposition U_{ϕ}, V_{ψ}, W_{τ}, ϕ, ω, τ of ALG. Let Πᵢ₌₁^{r}^{_{U}}U_{ϕ}⁽ⁱ⁾, Πⱼ₌₁^{r}^{_{V}}V_{ψ}^{(j)}, Πₗ₌₁^{r}^{_{W}}W_{τ}^{(l)} be a decomposition of U_{ϕ}, V_{ψ}, W_{τ}.

The arithmetic cost of ALG_{CAB}, for multiplying matrices of dimensions n×m and m×k where n=n₀^{l}, m=m₀^{l}, k=k₀^{l} for some l∈ [symbol] , is

$${F}_{{ALG}_{CAB}} ( n , m , k ) = ( \frac{{q}_{{U}_{ϕ}}^{*}}{t - {n}_{0} {m}_{0}} + \frac{{q}_{{V}_{ψ}}^{*}}{t - {m}_{0} {k}_{0}} + \frac{{q}_{{W}_{τ}^{T}}^{*}}{t - {n}_{0} {k}_{0}} + 1 ) {t}^{l}$$

$$- \frac{{q}_{{U}_{ϕ}}^{*} n m}{t - {n}_{0} {m}_{0}} - \frac{{q}_{{V}_{ψ}}^{*} m k}{t - {m}_{0} {k}_{0}} - \frac{{q}_{{W}_{τ}^{T}}^{*} n k}{t - {n}_{0} {k}_{0}} + \frac{{q}_{ϕ}}{{n}_{0} {m}_{0}} n m l + \frac{{q}_{ψ}}{{n}_{0} {m}_{0}} m k l + \frac{{q}_{{τ}^{T}}}{{n}_{0} {k}_{0}} n k l$$

Proof. The arithmetic cost for the base case is analyzed in claim 4.1. The proof follows by claim 4.1 and Corollary 2.14.

Claim 4.1. Let all parameters be the same as in Theorem 4. The communication cost of ALG_{CAB} for multiplying square matrices is

$$I {0}_{A L {G}_{C A B}} ( n , M ) = 0 ( {n}^{{log}_{{n}_{0}} t} \cdot {M}^{1 - \frac{{log}_{{n}_{0}} t}{2}} )$$

Proof. The proof follows by claims 2.16 and 7.

The costs of parallel and rectangular versions of this algorithm follow from claims similar to claim 5.

Claim 5. Let all parameters be the same as in Theorem 7. Then ALG_{CAB} performs q=q*_{U}+q*_{V}+q*_{W}_{^{T}} linear operations at its bilinear phase base case, where q*_{U}=Σᵢ₌₁^{r}^{_{U}}q_{U}_{⁽ⁱ⁾}, q*_{V}=Σᵢ₌₁^{r}^{_{V}}q_{V}_{⁽ⁱ⁾},

$${q}_{{W}^{T}}^{*} = {\sum }_{i = 1}^{{r}_{W}} {q}_{{( {W}^{( i )} )}^{T}}$$

(see Notation 2.3 hereinabove).

Proof. In the base case, the following computations are performed. First, the encoding of the input matrix A is computed by consecutively applying U^{(r}^{_{U}}⁾ to the input, the applying U^{(r}^{_{U}}⁻¹⁾ to the result of the first application, and so on until applying U⁽¹⁾. The cost of applying each of U⁽ⁱ⁾ for i∈[r_{U}] is given by q_{U}_{⁽ⁱ⁾} (Notation??). Combined, the cost of encoding A is q*_{U}=Σᵢ₌₁^{r}^{_{U}}q_{U}_{⁽ⁱ⁾}. Similarly, the cost of encoding B is q*_{V}=Σᵢ₌₁^{r}^{_{V}}q_{V}_{⁽ⁱ⁾} and the cost of decoding the result is

$${q}_{{W}^{T}}^{*} = {\sum }_{i = 1}^{{r}_{W}} {q}_{{( {W}^{( i )} )}^{T}}$$

### Comparing The Present Technique to the Fully Decomposed Sparse Decomposition Method

The sparse decomposition method enables reducing the arithmetic cost's leading coefficient

$${f}_{A L {G}_{S D M M}} = \frac{{q}_{{U}_{ϕ}} + {q}_{{V}_{ψ}} + {q}_{{w}_{τ}}}{t - {s}_{0}} + 1$$

(recall claim 2.16), in exchange for an increase in the asymptotic of the communication costs

$${IO}_{{ALG}_{SDMM}} = O ( {n}^{{log}_{{n}_{0}} t} \cdot {M}^{1 - {log}_{{s}_{0}} t} )$$

(see Corollary A1 hereinabove). There is a tuneable trade-off between the two, which can be used to improve performance.

A cost analysis of the present technique of combined alternative basis is provided hereinabove, when applying it to the alternative basis method (i.e., the sparse decomposition method when using automorphisms). In the last row of Table 3 hereinabove there is presented an example when applying the present technique of combined alternative basis to some sparse decomposition (see Beniamini and Schwartz '19) of the Ballard and Benson's [symbol] 3,3,3; 23 [symbol] -algorithm.

### Fully Decomposed Sparse Decomposition

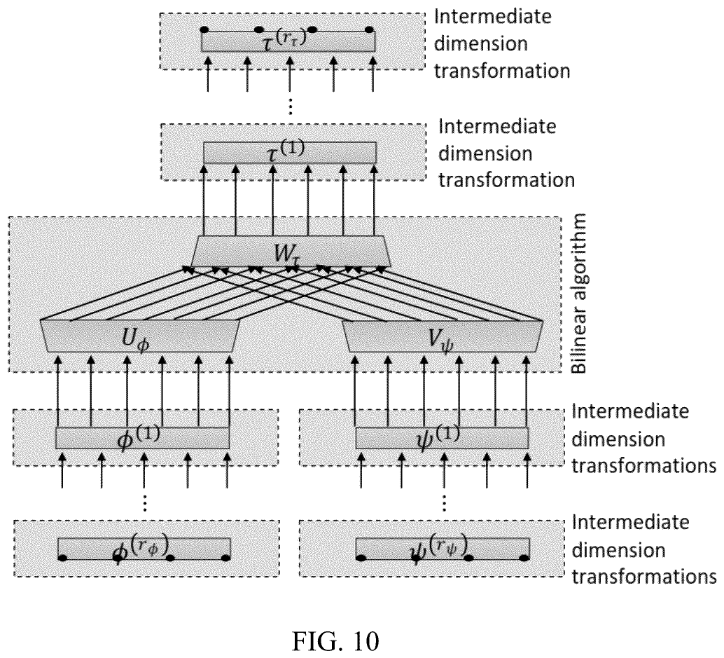

Applying the fully decomposed method of Beniamini and Schwartz '19 results in a reduced leading coefficient as well as reduced coefficients of lower order monomials. By repeatedly applying the sparse decomposition method, the coefficients of low order monomials can be reduced. In other words, each of the transformations ϕ, ψ, τ is decomposed into series of transformations ϕ⁽¹⁾, ϕ⁽²⁾, . . . , ϕ^{(r}^{_{ϕ}}⁾, ψ⁽¹⁾, ψ⁽²⁾, . . . , ψ^{(r}^{_{ψ}}⁾ and τ⁽¹⁾, τ⁽²⁾, . . . , τ^{(r}^{_{τ}}⁾ with descending dimensions, which are computed one after another. For the computation diagram see FIG. 10, and for an algorithmic representation, see Algorithm 9 below.

| Algorithm 9: Fully decomposed sparse decomposition | |
|---|---|
| matrix multiplication (Beniamini and Schwartz ’19) | |
| Input: A ∈ R^{n×m}, B ∈ R^{m×k} | |
| Output: C = A · B | |
| Function ALG_{FD-SDMM}(A, B): | |
| | 1. Denote Ã^{(r}^{_{ϕ}}⁺¹⁾ = \vec{A}, \tilde{B}^{(r}^{_{ψ}}⁺¹⁾ = \vec{B} |
| | 2. For i = r_{ϕ}, . . . , 1 do |
| | Compute \tilde{B}⁽ⁱ⁾ = ϕ⁽¹⁾(Ã⁽ⁱ⁺¹⁾) |
| | 3. For i = r_{ψ}, . . . , 1 do |
| | Compute \tilde{B}⁽ⁱ⁾ = ψ⁽¹⁾(\tilde{B}⁽ⁱ⁺¹⁾) |
| | 4. Compute \tilde{C}^{(r}^{_{τ}}⁾ = [symbol] (Ã⁽¹⁾, \tilde{B}⁽¹⁾) [symbol] Algorithm 3 |
| | 5. For i = 1, . . . , r_{τ} do |
| | Compute \tilde{C}⁽ⁱ⁾ = (τ⁽¹⁾)^{T} (\tilde{C}⁽ⁱ⁺¹⁾) |
| | 6. Denote \vec{C} = \tilde{C}⁽¹⁾ |
| | 7. return C |

### Comparison

The fully decomposed method will now be compared to the present technique of combined alternative basis. Both use Definition 3.1 hereinabove, (i.e., U=U_{ϕ}⁽¹⁾·U_{ϕ}⁽²⁾· . . . ·U_{ϕ}^{(r}^{_{U}}⁾·ϕ, and similarly for V and W). However, these methods differ in the resulting arithmetic and communication costs, in the objective function when decomposing U, V, W at preprocessing, and in the recursive structure of the resulting algorithm (see Algorithm 7 and Algorithm 9 above). Table 5 below provides details regarding the comparison between the two methods.

TABLE 5
Comparison between the sparse decomposition method and the present technique
of combined alternative basis.

| Comparison | Fully Decomposed Sparse | Combined Alternative Basis |
|---|---|---|
| Parameter | Decomposition | (Present Technique) |
| Arithmetic costs | Can be reduced drastically, | Can be reduced more than the |
| leading | often leading coefficient is 2. | Alternative Basis Method |
| coefficient | | [Karstadt and Schwartz '20]. |
| Communication | The exponent is increased. | The exponent is preserved. |
| costs asymptotics | | |
| Preprocessing | Minimize the number of linear | Minimize the total number of |
| decomposition | operations in the first matrix of | linear operations summed over |
| objective | the decomposition. Then repeat. | all matrices of the |
| | | decomposition: |
| | | $min {\sum }_{i = 1}^{{r}_{Q}} {q}_{{Q}^{( i )}} \\ s . t . Q = {Q}^{( 1 )} {Q}^{( 2 )} , … , {Q}^{( {r}_{Q} )}$ |
| | | where Q is an encoding or |
| | | transposed decoding matrix. |
| Recursive | Every matrix of the | A series of matrices in the |
| structure | decomposition corresponds to a | decomposition may correspond |
| | distinct recursion tree. | to a series of operations within a |
| | | single recursion tree. |

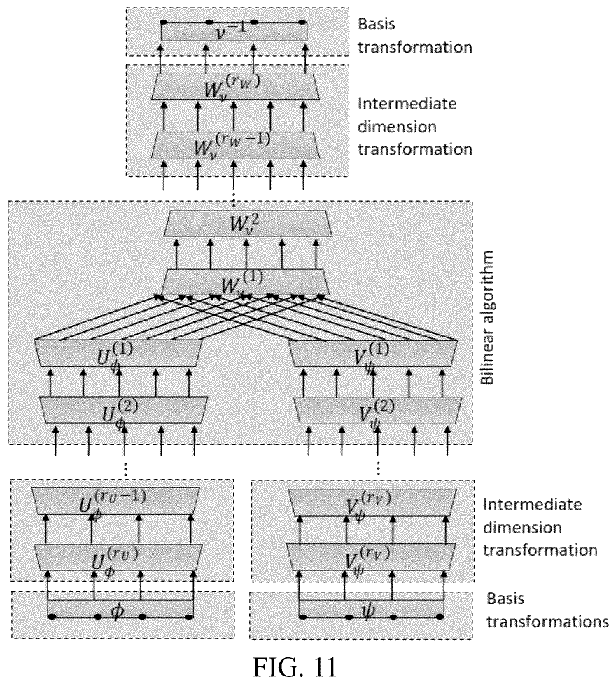

FIG. 11 shows the sparse decomposition method combined with the present technique of combined alternative basis.

### Decomposition Dimensions

The present Combined Alternative Basis method allows for arbitrary dimensions of the matrices in the decomposition. However, we next show that without loss of generality, the dimensions of optimal decomposition are monotone. That is, if the dimensions are l₁, . . . , lᵣ then l₁≥l₂≥ . . . ≥lᵣ.

Claim F.1. Let Q∈R^{t×s}^{_{Q}} be an encoding or decoding matrix of the bilinear phase of an algorithm. Let

$${Q}^{( 1 )} ∈ {R}^{t \times {l}_{1}} , … , {Q}^{( {r}_{Q} )} ∈ {R}^{{l}_{{r}_{Q}} \times {s}_{Q}}$$

be a decomposition of Q. Then there is a decomposition that minimizes Σᵢ₌₁^{r}^{_{Q}}q_{Q}_{⁽ⁱ⁾} and satisfies l₁≥l₂≥ . . . ≥lᵣ_{_{Q}}≥s_{Q}.

The proof is by induction on the following Lemma.

Lemma F.2. Let Q∈R^{t×s}^{_{Q}}, Q⁽¹⁾∈R^{t×l}, Q⁽²⁾∈R^{l×s}^{_{Q}} such that Q =Q⁽¹⁾·Q⁽²⁾. Then there exist two matrices \hat{Q}⁽¹⁾∈R^{t×l}′, \hat{Q}⁽²⁾∈R^{l}′^{×s}^{_{Q}}, Q=\hat{Q}⁽¹⁾·\hat{Q}⁽²⁾ that satisfy:
1. l′≥s_{Q}
2. q_{\hat{Q}}_{⁽¹⁾}+q_{\hat{Q}}_{⁽²⁾}=q_{Q}_{⁽¹⁾}+q_{Q}_{⁽²⁾}
3. \hat{Q}⁽²⁾ contains duplicate rows if and only if Q⁽²⁾ contains duplicate rows.

Proof. If l>s_{Q}, then the construction \hat{Q}⁽¹⁾=Q⁽¹⁾, \hat{Q}⁽²⁾=Q⁽²⁾ satisfies all three conditions. Otherwise, assume that Q is an encoding matrix and define \hat{Q}⁽¹⁾=(Q⁽¹⁾ 0),

$${\hat{Q}}^{( 2 )} = ( \begin{matrix}{Q}^{( 2 )} \\ I\end{matrix} )$$

where 0∈R^{t×(s}^{_{Q}}^{-l)} is the all zero matrix, and I∈R^{(s}^{_{Q}}^{-l)×s}^{_{Q}} contains rows of the identity matrix that do not appear in Q⁽²⁾. There are at least s_{Q}−l such rows since l<s_{Q} and Q⁽²⁾ contains at most l distinct rows. Note that l′=l+(s_{Q}−l)=S_{Q}. Therefore, by Notation??, q_{\hat{Q}}_{⁽¹⁾}=q_{Q}_{⁽¹⁾} and

$${q}_{{\hat{Q}}^{( 2 )}} = n n z ( {\hat{Q}}^{( 2 )} ) + n n s ( {\hat{Q}}^{( 2 )} ) - {l}^{′}$$

$$= nnz ( {Q}^{( 2 )} ) + ( {s}_{Q} - l ) + n n s ( {Q}^{( 2 )} ) - {s}_{Q}$$

$$= nnz ( {Q}^{( 2 )} ) + n n s ( {Q}^{( 2 )} ) - l = {q}_{{Q}^{( 2 )}} .$$

If Q⁽²⁾ contains duplicate rows, then these rows are duplicate in \hat{Q}⁽²⁾ as well. If Q⁽²⁾ does not contain duplicate rows, then the rows added in the construction do not add such duplication, since they are all distinct from the rows of Q⁽²⁾ and from each other.

Thus \hat{Q}⁽¹⁾, \hat{Q}⁽²⁾ satisfy the three conditions. The proof for a decoding matrix follows similarly.

### Lower Bounds

Following is the calculated lower bound on the leading coefficient of the Alternative Basis Method (Karstadt and Schwartz '20), of the Sparse Decomposition Method (Beniamini and Schwartz '19), and of the present technique of combined alternative basis. As detailed in Table 4 hereinabove, the lower bound matches several algorithms of the prior methods. In some embodiments,

This bound generalizes the lower bounds of (Karstadt and Schwartz '20). Both bounds show that the leading coefficient of any [symbol] 2,2,2; 7 [symbol] -algorithm utilizing the alternative basis or sparse decomposition methods is at least 5. In some embodiments, the present method provides for a more general bound, for encoding/decoding matrices [symbol] U, V, W [symbol] of any bilinear algorithm for which the encoding/decoding matrices are rectangular.

Notation 6.1. Let R be a ring and let A∈R^{m×n}. Denote by d_{A} the number of distinct rows in A, up to a multiplication by −1.

A proof for a lower bound for the alternative basis and sparse decomposition methods will now be provided. In Theorem 6.2 hereinbelow, this bound is generalized to hold for the present the present Combined Alternative Basis method as well.

Theorem 6.2. Let ALG_{SD} be a sparse decomposition of a bilinear algorithm with matrices U₉₉ , V_{ψ}, W_{τ}, ϕ, ψ, τ and levels t−S_{U}, t−S_{V}, t−S_{W}. Let f_{ALG}_{_{SD}} be the arithmetic cost's leading coefficient of the algorithm. Then

$${{f}_{ALG}}_{SD} \geq 5 - ( \frac{t - {d}_{U}}{t - {s}_{U}} + \frac{t - {d}_{V}}{t - {s}_{V}} + \frac{t - {d}_{W}}{t - {s}_{W}} ) .$$

As the alternative basis method of Karstadt and Schwartz is a special case of the sparse decomposition method, Theorem 6.2 also holds for the alternative basis method.

The leading coefficient 3.91 of (Beniamini et al.'s '20) decomposition of the [symbol] 2,3,2; 11 [symbol] -algorithm is optimal. This decomposition is a basis transformation, thus S_{U}, S_{V}, and S_{W} are the same as the matrices' dimensions. In addition, d_{U}=d_{V}=d_{W}=9, therefore, the leading coefficient of this algorithm is at least

$$5 - 2 \cdot \frac{2}{11 - 6} - \frac{2}{11 - 4} \approx 3.91 .$$

claim 6.3. Let A∈R^{t×s} for s<t, and assume that A has no zeroed rows. Then nnz(A)≥t+d_{A}−s

Proof. Up to s+t−d_{A} rows have a single non-zero entry. The other d_{A}−s rows contain at least two non-zero entries since they are not zeroed. In total, nnz(A)≥2(d_{A}−s)+s+t−d_{A}=t+d_{A}−s.

Proof of Theorem6.2. By claim 6.3, nnz(U)≥t+d_{U}−s_{U}. Hence, by Notation 2.3, q_{U}=nnz(U)+nns(U)−t≥t +d_{U}−s_{U}+0−t=(t−s_{U})−(t−d_{U}). Similarly, q_{V}≥(t−s_{V})−(t−dᵥ). As for W, it holds that q_{W}_{^{T}}=nnz(W)+nns(W)−s_{W}≥t+d_{W}−s_{W}+0−s_{W}=2·(t−s_{W})−(t−d_{W}). By claim 2.8, the leading coefficient of the arithmetic costs is:

$${f}_{A L {G}_{S D}} = \frac{{q}_{U}}{t - {s}_{U}} + \frac{{q}_{V}}{t - {s}_{V}} + \frac{{q}_{{W}^{T}}}{t - {s}_{W}} + 1 \geq$$

$$\frac{( t - {s}_{U} ) - ( t - {d}_{u} )}{t - {s}_{U}} + \frac{( t - {s}_{V} ) - ( t - {d}_{v} )}{t - {s}_{V}} + \frac{2 \cdot ( t - {s}_{W} ) - ( t - {d}_{w} )}{t - {s}_{W}} + 1 =$$

$$5 - ( \frac{t - {d}_{u}}{t - {s}_{U}} + \frac{t - {d}_{v}}{t - {s}_{V}} + \frac{t - {d}_{w}}{t - {s}_{W}} )$$

This proof works only for matrix multiplication algorithms, because claim 2.8 was proved only for matrix multiplication algorithms. However, claim 2.8 holds for any recursive bilinear algorithm that satisfies S_{U}, S_{V}, S_{W}<t. Therefore, Theorem 6.2 holds for any bilinear algorithm for which S_{U}, S_{V}, S_{W}<t.

Next, Theorem 6.2 is generalized, and a proof is provided for a lower bound on the leading coefficient of the arithmetic costs of the present Combined Alternative Basis method. To this end, it is shown that the arithmetic cost of decomposing an encoding matrix Q is at least t−s_{Q}−t−d_{Q}.

Theorem 6.5. Let ALG_{SD} be a sparse decomposition of a bilinear algorithm with matrices U_{ϕ}, V_{ψ}, W_{τ}, ϕ, ψ, τ and levels t−s_{U}, t−s_{V}, t−s_{W}. Let Πᵢ₌₁^{r}^{_{U}}U_{ϕ}⁽ⁱ⁾, Πⱼ₌₁^{r}^{_{V}}V_{ψ}^{(j)}, Πₗ₌₁^{r}^{_{W}}W_{τ}^{(l)} be a decomposition of U_{ϕ}, V_{ψ}, W_{τ}. Then

$${f}_{A L {G}_{S D}} \geq 5 - ( \frac{t - {d}_{U}}{t - {s}_{U}} + \frac{t - {d}_{V}}{t - {s}_{V}} + \frac{t - {d}_{W}}{t - {s}_{W}} ) .$$

The leading coefficient 4.11 of Beniamini et al.'s decomposition of the [symbol] 3,2,2; 11 [symbol] -algorithm when utilizing the present Combined Alternative Basis method is optimal. In this decomposition, s_{U}, s_{V}, and s_{W} are the same as the matrices' dimensions. In addition, d_{U}=d_{V}=9 while d_{W}=10, therefore, the leading coefficient of this algorithm is at least

$$5 - \frac{2}{11 - 6} - \frac{2}{11 - 4} - \frac{1}{11 - 6} \approx 4.11 .$$

Lemma 6.6. Let Q∈R^{t×s}^{_{Q}} be a matrix and let Q⁽¹⁾∈R^{t×l}, Q⁽²⁾∈R^{l×s}^{_{Q}} be a decomposition of Q. Then there exist two matrices \hat{Q}⁽¹⁾∈R^{t×l}′, \hat{Q}⁽²⁾∈R^{l}′^{×s}^{_{Q}}, Q=\hat{Q}⁽¹⁾·\hat{Q}⁽²⁾ that satisfy d_{Q}_{⁽²⁾}=l′ and q_{Q}_{⁽¹⁾}+q_{Q}_{⁽²⁾}≥q_{\hat{Q}}_{⁽¹⁾}+q_{\hat{Q}}_{⁽²⁾}.

Proof. Proof is provided only for encoding matrices. Assume that d_{Q}_{⁽²⁾}<l, then without loss of generality the last two rows of Q⁽²⁾ are identical. Denote the columns of Q⁽¹⁾ by q₁_{⁽¹⁾}, . . . , qₗ_{⁽¹⁾} and the rows of Q⁽²⁾ by q₁_{⁽²⁾}, . . . , qₗ_{⁽²⁾}.

Let \hat{Q}⁽¹⁾∈R^{t×(l-1)} be a matrix with columns q₁⁽¹⁾, . . . , qₗ₋₂⁽¹⁾, qₗ₋₁⁽¹⁾+qₗ⁽¹⁾. Let \hat{Q}⁽²⁾∈R^{(l-1)×s}^{_{Q}} be a matrix with rows q₁⁽²⁾, . . . , qₗ₋₁⁽¹⁾. Then Q=\hat{Q}⁽¹⁾·\hat{Q}⁽²⁾. By Notation 2.3,

$${q}_{{\hat{Q}}^{( 1 )}} = n n z ( {\hat{Q}}^{( 1 )} ) + n n s ( {\hat{Q}}^{( 1 )} ) - t \leq n n z ( {Q}^{( 1 )} ) + n n s ( {Q}^{( 1 )} ) - t = {q}_{{Q}^{( 1 )}}$$

$$and$$

$${q}_{{\hat{Q}}^{( 2 )}} =$$

$$nnz ( {\hat{Q}}^{( 2 )} ) + n n s ( {\hat{Q}}^{( 2 )} ) - l + 1 \leq n n z ( {Q}^{( 2 )} ) - 1 + n n s ( {Q}^{( 2 )} ) - l + 1 = {q}_{{Q}^{( 2 )}}$$

This can be repeated l−d_{Q}_{⁽²⁾} times to remove all duplicate rows. The proof for the decoding matrix differs only in the computation of q_{\hat{Q}}_{⁽¹⁾} and q_{\hat{Q}}_{⁽²⁾}.

Lemma 6.7. Let Q∈R^{t×s}^{_{Q}} be an encoding matrix. Let

$${Q}^{( 1 )} ∈ {R}^{t \times {l}_{1}} , {Q}^{( 2 )} ∈ {R}^{{l}_{1} \times {l}_{2}} , … , {Q}^{( {r}_{Q} )} ∈ {R}^{{l}_{{r}_{Q}} \times {s}_{Q}}$$

be a decomposition of Q. Denote l₀=t. Then q_{Q}≥(t−s_{Q})−(t−d_{Q}).

Proof. By claim 5 and by Notation 2.3 is holds that

$${q}_{Q} \geq {q}_{Q}^{*} = {\sum }_{i = 1}^{{r}_{Q}} {q}_{{Q}^{( i )}} = {\sum }_{i = 1}^{{r}_{Q}} ( n n z ( {Q}^{( i )} ) + n n s ( {Q}^{( i )} ) - {l}_{i - 1} )$$

By claim 6.3, ∀i: nnz(Q⁽ⁱ⁾)≥lᵢ₋₁+d_{Q}_{⁽ⁱ⁾}−lᵢ hence q_{Q}≥Σᵢ₌₁^{r}^{_{Q}}((lᵢ₋₁+d_{Q}_{⁽¹⁾}−lᵢ)−lᵢ₋₁). By Lemmas F.2 and 6.6, Σᵢ₌₁^{r}^{_{Q}}(d_{Q}_{⁽ⁱ⁾}−lᵢ)=d_{Q}_{⁽¹⁾}−lᵣ_{_{Q}}. In addition, d_{Q}≤d_{Q}_{⁽¹⁾}. Therefore q_{Q}≥d_{Q}_{⁽¹⁾}−lᵣ_{_{Q}}≥d_{Q}−s_{Q}=(t−s_{Q})−(t−d_{Q}).

Let Q∈R^{t×s}^{_{Q}} be a decoding matrix. Let

$${Q}^{( 1 )} ∈ {R}^{t \times {l}_{1}} , … , {Q}^{( {r}_{Q} )} ∈ {R}^{{l}_{{r}_{Q}} \times {s}_{Q}}$$

be a decomposition of Q. Then q_{Q}_{^{T}}≥2·(t−s_{Q})−(t−d_{Q}).

Proof of Lemma 6.7. The decomposition is optimal, therefore by claim 5 and by Notation 2.3 is holds that

$${q}_{{Q}^{T}} \geq {q}_{{Q}^{T}}^{*} = {\sum }_{i = 1}^{{r}_{Q}} {q}_{{Q}^{( i )}} = {\sum }_{i = 1}^{{r}_{Q}} ( n n z ( {Q}^{( i )} ) + n n s ( {Q}^{( i )} ) - {l}_{i} )$$

Since ∀i nnz(Q⁽ⁱ⁾)≥lᵢ₋₁+d_{Q}_{⁽ⁱ⁾}−lᵢ, hence

$${q}_{{Q}^{T}} \geq {\sum }_{i = 1}^{{r}_{Q}} ( ( {l}_{i - 1} + {d}_{{Q}^{( i )}} - {l}_{i} ) - {l}_{i} ) = {\sum }_{i = 1}^{{r}_{Q}} ( {d}_{{Q}^{( i )}} - {l}_{i} ) + t - {s}_{Q}$$

By Lemmas F.1 and 6.6 Σᵢ₌₁^{r}^{_{Q}}(d_{Q}_{⁽ⁱ⁾}−lᵢ)=d_{Q}_{⁽¹⁾}−lᵣ_{_{Q}} therefore

$${q}_{Q} \geq {d}_{{Q}^{( 1 )}} - {l}_{{r}_{Q}} + t - {s}_{Q} \geq {d}_{Q} - {s}_{Q} + t - {s}_{Q} =$$

$$2 \cdot ( t - {s}_{Q} ) - ( t - {q}_{Q} )$$

since if A·B=C then d_{C}≤d_{A}.

Proof of Theorem 6.5. By Lemmas 6.6 and 6.7 and by claim 2.10

$${f}_{A L {G}_{S D}} = \frac{{q}_{U}}{t - {s}_{U}} + \frac{{q}_{V}}{t - {s}_{V}} + \frac{{q}_{W}}{t - {s}_{W}} + 1 \geq$$

$$\frac{( t - {s}_{U} ) - ( t - {d}_{U} )}{t - {s}_{U}} + \frac{( t - {s}_{V} ) - ( t - {d}_{V} )}{t - {s}_{V}} + \frac{2 \cdot ( t - {s}_{W} ) - ( t - {d}_{W} )}{t - {s}_{W}} + 1 =$$

$$5 - ( \frac{t - {d}_{U}}{t - {s}_{U}} + \frac{t - {d}_{V}}{t - {s}_{V}} + \frac{t - {d}_{W}}{t - {s}_{W}} )$$

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and/or hardware.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving two or more input matrices for a multiplication operation to be performed using a computer system;
determining, for each of said input matrices, a series of transformations, and applying said series of transformations respectively to said input matrices to obtain transformed said input matrices,
wherein each of said series of transformations reduces a number of arithmetic operations required to perform said multiplication operation, given a desired value of communication costs required to perform said multiplication operation using said computer system, and
wherein each of said series of transformations is performed over two or more recursions, wherein at least one of said recursions comprises at least two said transformations;
applying a recursive bilinear computation to said transformed two or more input matrices, thereby producing a transformed multiplied matrix; and
determining an output series of transformations which are applied to said transformed multiplied matrix, to obtain a product of said at least two input matrices,
wherein said computer system comprises one or more processors and a communication network, wherein each of said processors is configured to perform matrix multiplication on blocks of size n, and wherein said computer system is configured to balance arithmetic and communication costs associated with performing said matrix multiplication, such that a time period required to transfer said blocks to a processor of said one or more processors via said communication network is approximately equal to a time period required to perform said matrix multiplication on said blocks by said processor.

2. The computer-implemented method of claim 1, wherein at least some of said transformations are homomorphic.

3. The computer-implemented method of claim 1, wherein at least some of said transformations are non-homomorphic.

4. The computer-implemented method of claim 1, wherein said number of recursions is determined based on a search algorithm which allocates said series of transformations into said recursions.

5. The computer-implemented method of claim 1, further comprising multiplying each of said input matrices by an alternative basis transformation that is invertible to an inverted basis transformation, to obtain alternative basis input matrices, wherein said series of transformations is applied to said alternative basis input matrices, and wherein said applying of said recursive bilinear computation produces an alternative basis transformed multiplied matrix.

6. The computer-implemented method of claim 5, further comprising multiplying said alternative basis transformed multiplied matrix by said inverted basis transformation, to obtain a product of said at least two input matrices.

7. The computer-implemented method of claim 1, wherein said balance is achieved by adjusting at least one of the following parameters of said computer system: a silicone area of each of said processors, a processing speed of each of said processors, a size of a local memory associated with each of said processors, a size of a shared memory accessible to all of said processors, a bandwidth of said communication network, and/or a latency of said communication network.

8. The computer-implemented method of claim 7, wherein said adjusting is performed according to the equation
$$γ {M}^{\frac{{ω}_{0}}{2}} \approx c ( α + β M ) ,$$
n=Θ(\sqrt{M}), where ω₀ denotes an exponent of said recursive bilinear computation, γ denotes the time required for a single arithmetic operation by a processor of said one or more processors, α denotes said latency, β denotes said bandwidth, M denotes a size of a local memory associated with each of said processors, n denotes a size of said blocks, and c is a constant determined by a number of read and write operations required for said matrix multiplication.

9. A system comprising:
at least one processor; and
a non-transitory computer-readable storage medium having stored thereon program instructions, the program instructions executable by the at least one processor to:
receive two or more input matrices for a multiplication operation,
determine, for each of said input matrices, a series of transformations, and apply said series of transformations respectively to said input matrices to obtain transformed said input matrices,
wherein each of said series of transformations reduces a number of arithmetic operations required to perform said multiplication operation, given a desired value of communication costs required to perform said multiplication operation using said system, and
wherein each of said series of transformations is performed over two or more recursions, wherein at least one of said recursions comprises at least two said transformations,
apply a recursive bilinear computation to said transformed two or more input matrices, thereby producing a transformed multiplied matrix, and
determine an output series of transformations which are applied to said transformed multiplied matrix, to obtain a product of said at least two input matrices,
wherein said system further comprises a communication network, wherein each of said at processors is configured to perform matrix multiplication on blocks of size n, and wherein said system is configured to balance arithmetic and communication costs associated with performing said matrix multiplication, such that a time period required to transfer said blocks to a processor of said one or more processors via said communication network is approximately equal to a time period required to perform said matrix multiplication on said blocks by said processor.

10. The system of claim 9, wherein at least some of said transformations are homomorphic.

11. The system of claim 9, wherein at least some of said transformations are non- homomorphic.

12. The system of claim 9, wherein said number of recursions is determined based on a search algorithm which allocates said series of transformations into said recursions.

13. The system of claim 9, wherein said program instructions are further executable to multiply each of said input matrices by an alternative basis transformation that is invertible to an inverted basis transformation, to obtain alternative basis input matrices, wherein said series of transformations is applied to said alternative basis input matrices, and wherein said applying of said recursive bilinear computation produces an alternative basis transformed multiplied matrix.

14. The system of claim 13, wherein said program instructions are further executable to multiply said alternative basis transformed multiplied matrix by said inverted basis transformation, to obtain a product of said at least two input matrices.

15. The system of claim 9, wherein said balance is achieved by adjusting at least one of the following parameters of said system: a silicone area of each of said processors, a processing speed of each of said processors, a size of a local memory associated with each of said processors, a size of a shared memory accessible to all of said processors, a bandwidth of said communication network, and/or a latency of said communication network.

16. The system of claim 15, wherein said adjusting is performed according to the equation
$$γ {M}^{\frac{{ω}_{0}}{2}} \approx c ( α + β M ) ,$$
n=Θ(\sqrt{M}), where ω₀ denotes an exponent of said recursive bilinear computation, γ denotes the time required for a single arithmetic operation by a processor of said one or more processors, α denotes said latency, β denotes said bandwidth, M denotes a size of a local memory associated with each of said processors, n denotes a size of said blocks, and c is a constant determined by a number of read and write operations required for said matrix multiplication.

17. A computer program product comprising a non-transitory computer-readable storage medium having program instructions embodied therewith, the program instructions executable by a computer system to:
receive two or more input matrices for a multiplication operation,
determine, for each of said input matrices, a series of transformations, and apply said series of transformations respectively to said input matrices to obtain transformed said input matrices,
wherein each of said series of transformations reduces a number of arithmetic operations required to perform said multiplication operation, given a desired value of communication costs required to perform said multiplication operation using said computer system, and
wherein each of said series of transformations is performed over two or more recursions, wherein at least one of said recursions comprises at least two said transformations,
apply a recursive bilinear computation to said transformed two or more input matrices, thereby producing a transformed multiplied matrix, and
determine an output series of transformations which are applied to said transformed multiplied matrix, to obtain a product of said at least two input matrices,
wherein said computer system comprises one or more processors and a communication network, wherein each of said processors is configured to perform matrix multiplication on blocks of size n, and wherein said computer system is configured to balance arithmetic and communication costs associated with performing said matrix multiplication, such that a time period required to transfer said blocks to a processor of said one or more processors via said communication network is approximately equal to a time period required to perform said matrix multiplication on said blocks on said blocks by said processor.

18. The computer program product of claim 17, wherein at least some of said transformations are homomorphic.

19. The computer program product of claim 17, wherein at least some of said transformations are non-homomorphic.

20. The computer program product of claim 17, wherein said number of recursions is determined based on a search algorithm which allocates said series of transformations into said recursions.

21. The computer program product of claim 17, wherein said program instructions are further executable to multiply each of said input matrices by an alternative basis transformation that is invertible to an inverted basis transformation, to obtain alternative basis input matrices, wherein said series of transformations is applied to said alternative basis input matrices, and wherein said applying of said recursive bilinear computation produces an alternative basis transformed multiplied matrix.

22. The computer program product of claim 21, wherein said program instructions are further executable to multiply said alternative basis transformed multiplied matrix by said inverted basis transformation, to obtain a product of said at least two input matrices.

23. The computer program product of claim 17, wherein said balance is achieved by adjusting at least one of the following parameters of said computer system: a silicone area of each of said processors, a processing speed of each of said processors, a size of a local memory associated with each of said processors, a size of a shared memory accessible to all of said processors, a bandwidth of said communication network, and/or a latency of said communication network.

24. The computer program product of claim 23, wherein said adjusting is performed according to the equation
$$γ {M}^{\frac{{ω}_{0}}{2}} \approx c ( α + β M ) ,$$
n=Θ(\sqrt{M}), where ω₀ denotes an exponent of said recursive bilinear computation, γ denotes the time required for a single arithmetic operation by a processor of said one or more processors, α denotes said latency, β denotes said bandwidth, M denotes a size of a local memory associated with each of said processors, n denotes a size of said blocks, and c is a constant determined by a number of read and write operations required for said matrix multiplication.

25. A computer system comprising:
one or more processors, each configured to perform matrix multiplication on blocks of size n; and
a communication network,
wherein said computer system is configured to balance arithmetic and communication costs associated with performing said matrix multiplication, such that a time period required to transfer said blocks to a processor of said one or more processors via said communication network is approximately equal to a time period required to perform said matrix multiplication on said blocks by said processor.

26. The computer system of claim 25, wherein said computer system is configured to perform a matrix multiplication operation with respect to two or more input matrices, said matrix multiplication operation comprising the following steps:
receiving two or more input matrices for a multiplication operation to be performed using a computer system;
determining, for each of said input matrices, a series of transformations, and applying said series of transformations respectively to said input matrices to obtain transformed said input matrices,
wherein each of said series of transformations reduces a number of arithmetic operations required to perform said multiplication operation, given a desired value of communication costs required to perform said multiplication operation using said computer system, and
wherein each of said series of transformations is performed over two or more recursions, wherein at least one of said recursions comprises at least two said transformations;
applying a recursive bilinear computation to said transformed two or more input matrices, thereby producing a transformed multiplied matrix; and
determining an output series of transformations which are applied to said transformed multiplied matrix, to obtain a product of said at least two input matrices.

27. The computer system of claim 25, wherein said balance is achieved by adjusting at least one of the following parameters: a silicone area of each of said processors, a processing speed of each of said processors, a size of a local memory associated with each of said processors, a size of a shared memory accessible to all of said processors, a bandwidth of said communication network, and/or a latency of said communication network.

28. The computer system of claim 27, wherein said adjusting is performed according to the equation
$$γ {M}^{\frac{{ω}_{0}}{2}} \approx c ( α + β M ) ,$$
n=Θ(\sqrt{M}), where ω₀ denotes an exponent of said recursive bilinear computation, γ denotes the time required for a single arithmetic operation by a processor of said one or more processors, α denotes said latency, β denotes said bandwidth, M denotes a size of a local memory associated with each of said processors, n denotes a size of said blocks, and c is a constant determined by a number of read and write operations required for said matrix multiplication.
